(19) United States
(12) Patent Application Publication
(10) Pub. No.: US 2018/0095492 A1
(43) Pub. Date: Apr. 5, 2018

(54) DUAL-MODE JOYSTICK

(71) Applicant: Rooftop Group International Pte. Ltd., Singapore (SG)

(72) Inventor: Darren Scott Matloff, Austin, TX (US)

(21) Appl. No.: 15/649,400

(22) Filed: Jul. 13, 2017

Related U.S. Application Data
(60) Provisional application No. 62/362,548, filed on Jul. 14, 2016.

(51) Int. Cl. G05G 9/047; A63H 30/04; G05D 1/00; G05G 1/04; G05G 5/05

(52) U.S. Cl. CPC G05G 9/047; A63H 30/04; B64C 39/024; G05G 1/04; G05G 5/05; G05D 1/0016

(57) ABSTRACT

A dual-mode joystick of a remote control unit can control an unmanned flying device in a selectable center-sprung or non-sprung mode. In the center-sprung mode, the joystick can be spring-biased in equilibrium at the centered position. The joystick is not spring-biased in equilibrium at the centered position in the non-sprung mode. In addition, a friction force can be used in the non-sprung mode to hold the joystick in a stationary rotational position until an external force is applied to overcome the friction force.

### CROSS-REFERENCE TO RELATED APPLICATIONS

This application claims the benefit of U.S. Provisional Application No. 62/362,548, filed Jul. 14, 2016, titled DRONE WITH A JOYSTICK; which is incorporated by reference herein in its entirety.

Any and all applications for which a foreign or domestic priority claim is identified in the Application Data Sheet as filed with the present application are hereby incorporated by reference under 37 CFR 1.57.

### FIELD

The present disclosure relates to unmanned flying devices or drones for recreational use. In particular, the present disclosure relates to a joystick of a controller of an unmanned flying devices or drone.

### BACKGROUND

Unmanned flying devices or drones have become quite popular for both commercial and recreational use. Advancements in drone technology will further assist in expanding the consumer market for drones and aid in advancing this technology. Various remote control airplanes, helicopters, quadcopters, and the like are available on the market. With increasing miniaturization of electronics and development of new battery and motor technologies, such devices have become cheaper to manufacture, more reliable, and more popular. Some such devices are even making their way into commercial and other non-toy uses, such as for aerial photography, search and rescue, package delivery, and the like.

Recreational unmanned flying devices or drones typically can be controlled by a remote control device having one or more gimbals each having a stick, joystick, or lever arm. The user can manipulate or rotate the lever arm about two axes, typically in a forward and backward direction and a left and right direction. Each axis can represent a channel of user input. For example, the left joystick may control throttle along a forward/backward axis and yaw along a left/right axis. The right joystick may control pitch along a forward/backward axis, and roll along a left/right axis.

### SUMMARY

Example embodiments of the present disclosure provide a joystick or lever arm of a controller that can operate in either a center-sprung or in a non-sprung manner about one or more axes or directions of rotation. Users are able to switch or toggle the lever arms between two operating styles of center sprung or non-sprung.

A remote control unit for wirelessly controlling an unmanned flying device, the remote control unit having a user input with selectable center sprung and non-sprung modes, can comprise a gimbal configured for rotation in a first direction and a second direction, the first direction being substantially perpendicular to the second direction, the gimbal comprising a lever arm configured for manipulation by a user to effectuate rotation in the first and second directions; at least one spring operably connected to the gimbal and configured to return the lever arm to a center position in the center sprung mode after the lever arm is released from a non-center position in the first direction, wherein the gimbal can be operably disconnected from the spring in the non-sprung mode; a barometric pressure sensor switch comprising activated and deactivated configurations; a mechanical mode toggle configured to operably connect the gimbal to the spring and activate the barometric pressure sensor switch in the center-sprung mode, and to operably disconnect the gimbal from the spring and deactivate the barometric pressure sensor switch in the non-sprung mode; and a controller configured to wirelessly communicate with the unmanned flying device, the controller configured to, responsive to detecting activation or deactivation of the barometric pressure sensor switch, transmit data to the unmanned flying device to cause the unmanned flying device to activate or deactivate a barometric pressure sensor. The remote control unit can further comprise a rocker arm coupled to one end of the at least one spring, the lever arm being connected to two bars in the first direction with one bar on each side of a center of rotation of the lever arm in the first direction, the bars and the rocker arm being in contact in the center-sprung mode such that rotation of the lever arm throughout a range of motion in the first direction can be translated to movements of the rocker arm by at least one of the two bars and exert a tensile force on the at least one spring, wherein the bars and the rocker arm are not in contact in the non-sprung mode such that rotation of the lever arm throughout the range of motion in the first direction does not exert a tensile force on the at least one spring. The remote control unit can further comprise a leaf spring and a friction element, the friction element operably connected to the lever arm, wherein the leaf spring can be in contact with the friction surface in the non-sprung mode, and can be moved out of contact with the friction surface in the center-sprung mode. The mechanical mode toggle can comprise a hook, the friction element comprising a friction wheel, the hook pushing the leaf spring out of contact with the friction wheel in the center-sprung mode. The friction element can be configured to maintain a position of the lever arm in the non-sprung mode after the lever arm has been rotated in the first direction until an external force overcomes a friction between the friction element and the leaf spring. The mechanical mode toggle can disengage the barometric pressure sensor switch in the center sprung mode and engages the barometric pressure sensor switch in the non-sprung mode. The mechanical mode toggle can comprise a slot configured to accommodate a pin on the rocker arm, wherein the mechanical mode toggle can be configured to rotate to push the pin to a first location to bring at least one of the two bars into contact with the rocker arm in the center-sprung mode, the pin configured to move freely in the slot in the center-sprung mode, and wherein the mechanical mode toggle can be configured to rotate to push the pin to a second location to bring both of the two bars out of contact with the rocker arm, the pin being push to one end of the slot in the non-sprung mode. The remote control unit can further comprise a torsional spring mounted at one end on an outer housing of the remote control unit, the torsional spring being connected to the mechanical mode toggle on another end, wherein the torsional spring can lock the toggle into in the center-sprung mode by biasing in a first direction and can lock the toggle into the non-sprung mode by biasing in a second direction opposite the first direction. The mechanical mode toggle can comprise a thumb wheel. When activated, the barometric pressure sensor can be configured to maintain an altitude of the drone. When the barometric pressure sensor is deactivated, an altitude of the drone can be maintained by a position of the lever arm in the first direction.

A remote control unit for wirelessly controlling an unmanned flying device, the remote control unit having a user input with selectable center sprung and non-sprung modes, can comprise a gimbal configured for rotation in a first direction and a second direction, the first direction being substantially perpendicular to the second direction, the gimbal comprising a lever arm configured for manipulation by a user to effectuate rotation in the first and second directions, the gimbal further comprising a friction surface that, when in contact with a stopper arm in the center-sprung mode, can be configured to hold the lever am in a stationary rotational position with respect to the first direction until an external force is applied to the lever arm that overcomes a friction force between the friction surface and the stopper arm; at least one spring operably connected to the gimbal and configured to return the lever arm to a center position in the center sprung mode after the lever arm is released from a non-center position in the first direction, wherein the gimbal can be operably disconnected from the spring in the non-sprung mode; a barometric pressure sensor switch comprising activated and deactivated configurations; a mechanical mode toggle, the mechanical mode toggle further comprising a hook, wherein in the center-sprung mode, the mechanical toggle can be configured to operably connect the gimbal to the spring, deactivate the barometric pressure sensor switch, and cause the hook to push the stopper arm away from the friction surface, and when in the non-sprung mode, the mechanical mode toggle can be configured to operably disconnect the gimbal from the spring, activate the barometric pressure sensor switch, and causes the hook to push the stopper arm against the friction surface; and a controller configured to wirelessly communicate with the unmanned flying device, the controller configured to, responsive to detecting activation or deactivation of the barometric pressure sensor switch, transmit data to the unmanned flying device to cause the unmanned flying device to activate or deactivate a barometric pressure sensor. The remote control unit can further comprise a rocker arm coupled to one end of the at least one spring, the lever arm being connected to two bars in the first direction with one bar on each side of a center of rotation of the lever arm in the first direction, the bars and the rocker arm being in contact in the center-sprung mode such that rotation of the lever arm throughout a range of motion in the first direction can be translated to movements of the rocker arm by at least one of the two bars and exert a tensile force on the at least one spring, wherein the bars and the rocker arm are not in contact in the non-sprung mode such that rotation of the lever arm throughout the range of motion in the first direction does not exert a tensile force on the at least one spring. The rocker arm can comprise a pin, the pin being biased to a first location to bring at least one of the two bars into contact with the rocker arm in the center-sprung mode, and wherein the mechanical mode toggle can be configured to rotate to push the pin to a second location to bring both of the two bars out of contact with the rocker arm in the non-sprung mode. The mechanical mode toggle can disengage the barometric pressure sensor switch to activate the switch in the center sprung mode and can engage the barometric pressure sensor switch to deactivate the switch in the non-sprung mode. The remote control unit can further comprise a torsional spring mounted at one end on an outer housing of the remote control unit, the torsional spring being connected to the mechanical mode toggle on another end, wherein the torsional spring can lock the toggle into in the center-sprung mode by biasing in a first direction and can lock the toggle into the non-sprung mode by biasing in a second direction opposite the first direction. The mechanical mode toggle can comprise a thumb wheel. When activated, the barometric pressure sensor can be configured to maintain an altitude of the drone. When the barometric pressure sensor is deactivated, an altitude of the drone can be maintained by a position of the lever arm in the first direction.

A remote control unit for wirelessly controlling an unmanned flying device, the remote control unit having a user input with selectable center sprung and non-sprung modes, can comprise a gimbal comprising a stationary housing and a rotatable drum, the drum pivotally coupled to the housing such that the drum can rotate with respect to the housing about a first axis; a joystick coupled to the drum, the joystick configured for manipulation by a user to cause rotation of the drum about the first axis; a rocker arm pivotally coupled to the housing such that the rocker arm can rotate with respect to the housing about a second axis, wherein the drum comprises first and second laterally protruding members positioned to engage the rocker arm; a spring coupled to the rocker arm and configured to bias the rocker arm toward the first and second laterally protruding members of the drum, wherein the laterally protruding members and the rocker arm are positioned such that, when the rocker arm engages one or both of the laterally protruding members, the spring and rocker arm bias the joystick toward a centered position; and a toggle switch configured for manipulation by a user to alternate the gimbal between center sprung and non-sprung modes, the toggle switch having first and second positions, wherein, when the toggle switch is in the first position, the rocker arm can be able to engage at least one of the first and second laterally protruding members throughout a range of motion of the joystick, to cause the joystick to be center sprung about the first axis, and wherein, when the toggle switch is in the second position, the rocker arm can be forced out of engagement with both the first and the second laterally protruding members, to cause the joystick to be non-sprung about the first axis. The rocker arm can comprise a laterally protruding member that extends into a slot of the toggle switch, the slot shaped such that, when the toggle switch is in the first position, the laterally protruding member of the rocker arm can move freely within the slot in response to rotation of the drum about the first axis, and when the toggle switch is in the second position, the laterally protruding member of the rocker arm can be forced against an end of the slot. The rocker arm can comprise a laterally protruding member and the toggle switch can comprise a laterally protruding member, the laterally protruding members of the rocker arm and toggle switch positioned such that, when the when the toggle switch is in the first position, the laterally protruding member of the rocker arm can move freely relative to the laterally protruding member of the toggle switch in response to rotation of the drum about the first axis, and when the toggle switch is in the second position, the laterally protruding member of the rocker arm can be forced against the laterally protruding member of the toggle switch. The remote control unit can further comprise a friction member positioned to contact a surface of the drum such that, when the joystick is non-sprung about the first axis, the joystick can be held in a stationary rotational position with respect to the first axis until an external force is applied to the joystick that overcomes a friction force between the friction member and the surface of the drum, and wherein, when the toggle switch is in the first position, the friction member can be forced out of engagement with the surface of the drum. The remote control unit can further comprise an electronic switch positioned to detect whether the toggle switch is in the first position or the second position. The remote control unit can further comprise a transmitter configured to transmit data to an unmanned flying device, the data comprising at least an indication of a present state of the electronic switch.

### BRIEF DESCRIPTION OF THE DRAWINGS

Various embodiments will be described hereinafter with reference to the accompanying drawings. These embodiments are illustrated and described by example only, and are not intended to limit the scope of the disclosure. In the drawings, similar elements have similar reference numerals.

FIG. 1 illustrates a perspective view of an example remote control unit of a drone having a first gimbal and a second gimbal.

FIG. 2 illustrates a top view of an example remote control unit of a drone having a first gimbal and a second gimbal.

FIG. 3A illustrates an exploded view of an example first gimbal.

FIGS. 3B-D illustrate perspective, elevation, and top partially exploded views of the first gimbal of FIG. 1.

FIGS. 4A-B illustrates perspective and end views of the first gimbal of FIG. 1 with certain features removed for clarity.

FIG. 5A illustrates a side view of the first gimbal of FIG. 1 with certain features removed for clarity.

FIGS. 5B-C illustrate perspective views of example torsional springs.

FIGS. 5D-E illustrate schematically an example mode locking mechanism having a torsional spring.

FIGS. 6A-E illustrate an example first gimbal in which a center-sprung/non-sprung mode toggle is in a first position.

FIGS. 7A-D illustrate an example first gimbal in which a center-sprung/non-sprung mode toggle is in a second position.

FIG. 8 is a block system diagram illustrating various components of an example drone and an example remote control.

FIGS. 9A-E illustrate another example first gimbal in which a center-sprung/non-sprung mode toggle is in a first position.

FIGS. 10A-E illustrate another example first gimbal in which a center-sprung/non-sprung mode toggle is in a second position.

FIG. 11A illustrates an exploded view of the first gimbal of FIGS. 9A-E and 10A-E.

FIG. 11B illustrates an exploded view of certain components of the first gimbal of FIGS. 9A-E and 10A-E, with the rest of the components hidden for clarity.

### DETAILED DESCRIPTION

Although certain embodiments and examples are described below, it is intended that the scope of the disclosure herein disclosed should not be limited by any particular embodiments described below.

Unmanned flying devices, such as small battery-powered multi-rotor aircraft, sometimes referred to as drones, are becoming increasingly popular. Such devices can be used for entertainment and commercial purposes. For example, unmanned flying devices can be used for aerial photography and other purposes. The terms “drone” or “flying device” are used herein to refer to an unmanned flying device, whether the device is remotely controlled and/or comprises at least some self-guidance, self-stabilization, and/or autonomous flight technology. In some embodiments, the term flying device may be used to refer to what is commonly known as a quadcopter that comprises four propellers and a computer or microcontroller configured to individually vary the speed of each of those propellers to enable the quadcopter to fly in a desired manner. Other unmanned flying device or drones may be, for example, a tricopter, a hexacopter, a pentacopter, an octocopter, a helicopter, an airplane, and/or the like. Further, unmanned flying devices or drones can be fully self-guided or autonomous, meaning no external user input is required in real time during flight, and/or require at least some external user input during flight.

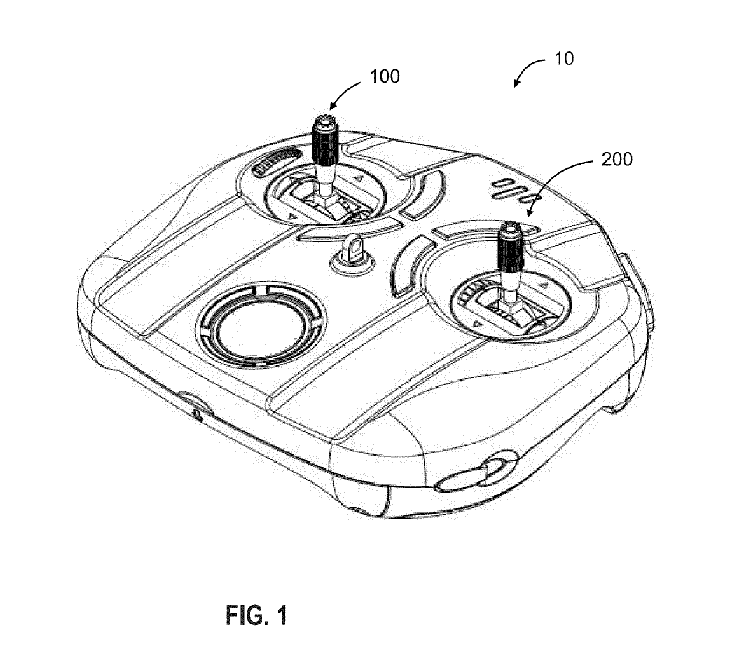

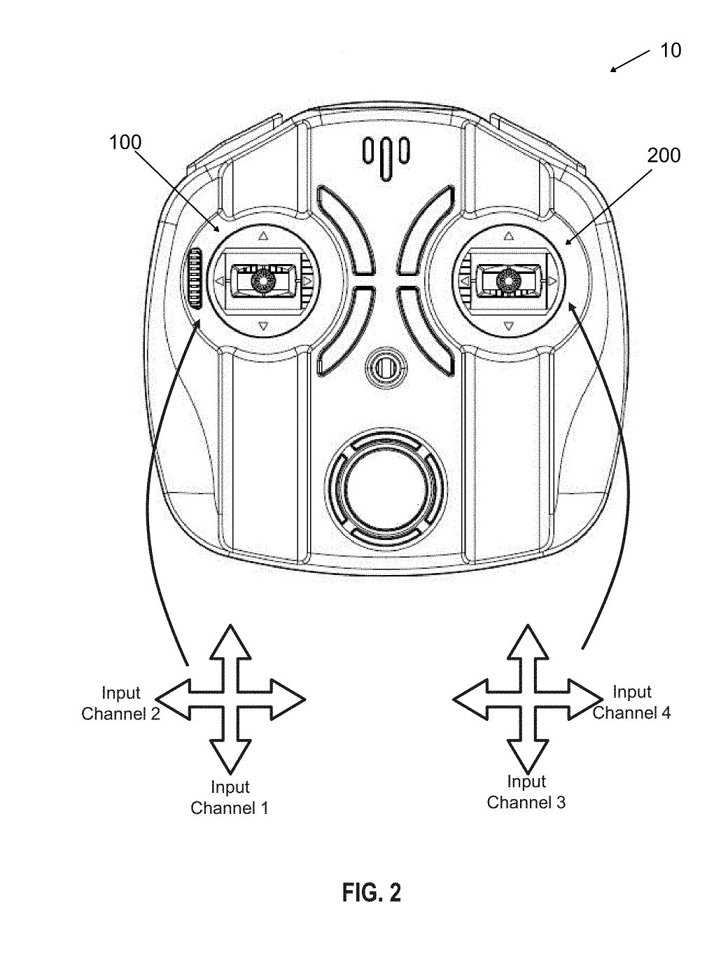

The drones are typically remotely controlled by a remote control unit having two joysticks, each joystick coupled to a two-axis gimbal. FIGS. 1 and 2 show an example embodiment of a remote control unit 10 according to the present disclosure. The remote control unit 10 is illustrated as having a first gimbal 100 and a second gimbal 200. Each of the first and second gimbals 100, 200 can be configured to enable at least two channels of user input, such as a first channel in a forward/backward direction (i.e. rotation about an axis oriented horizontally with respect to FIG. 2) and a second channel in a left/right direction (i.e. rotation about an axis oriented vertically with respect to FIG. 2). In FIG. 2, these various user input channels are labeled Input Channels 1-4. These user input channels can be mapped to corresponding drone flight control channels, such as throttle, pitch, roll, yaw, and the like. In some embodiments, the remote control unit can have only one gimbal or more than two gimbals.

In a typical two joystick remote control device for a drone, the left joystick is center-sprung in the left/right direction (i.e. channel 2), the left joystick is non-sprung in the forward/backward direction (i.e. channel 1), and the right joystick is center-sprung in both directions (i.e. channels 3 and 4). Center-sprung means that the joystick is biased to remain in a centered position (such as the position the joysticks are shown in FIGS. 1 and 2), and thus the joystick will return to that centered position if a user moves the joystick off-center and then releases the joystick. Non-sprung means the joystick is not biased to remain in the centered position, and thus if a user moves the joystick off-center and then releases the joystick, the joystick will remain in the off-center position.

It can be desirable for the axes of rotation associated with channels two through four to be center sprung, because these channels are typically associated with pitch, roll, and yaw flight control channels. These channels ideally remain centered, and a user can move each channel in a positive or negative direction, depending on how the user wishes to change the orientation and/or direction of flight. For example, if the entire range of input values that can be given to pitch, roll, and yaw inputs is given as a numerical range, the joystick at the centered position would be zero, and moving the joystick away from that centered position would result in a positive or negative number, depending on which direction the joystick is moved. Channel 1, on the other hand, is typically associated with throttle. The throttle scale is typically from a minimum of zero (corresponding to the joystick positioned at one end of the range of motion) to some maximum positive number (corresponding to the joystick positioned at another end of the range of motion), instead of a scale centered on zero. Further, to maintain stable flight, it can be desirable to set a particular throttle value and leave the throttle set at that value, instead of having the joystick channel associated with throttle spring back to any particular value. Accordingly, a typical drone remote control unit can comprise two joystick gimbals, each associated with two channels of user input, with the throttle channel being non-sprung and the other three channels being center-sprung.

Although the increasing capability of miniature computer processors has enabled drones and other unmanned flying devices to incorporate automatic stabilization controls that make them increasingly easy for a user to operate, there can still be a relatively steep learning curve to learning how to successfully pilot a drone. The embodiments disclosed herein present features that can make a drone easier to control, even for a beginner. For example, some embodiments disclosed herein comprise a remote control unit having a joystick channel that can be user selectable to be center-sprung or non-sprung. One example of such a remote control device 10 is illustrated in FIGS. 1 and 2. In the embodiment illustrated in FIGS. 1 and 2, input channel one (the forward and back motion of the left joystick 100) can be switched by a user between center sprung and non-sprung modes. In a non-sprung mode, channel one can be configured to control a drone similarly to a typical drone remote controller, such as by controlling throttle of the drone on a scale from zero at one extent of the range of travel, to a maximum throttle value at the other extent of the range of travel.

In a center sprung mode, however, channel 1 can be center-sprung and configured to make it easier for a beginner to operate the drone. For example, in one embodiment, when a user switches channel 1 to be center sprung, the remote control unit 10 can further be configured to change how the drone will respond to movement of the joystick associated with channel 1. For example, instead of channel 1 controlling a throttle of the drone, channel 1 can be configured to cause incremental changes in altitude or elevation of the drone. For example, when channel 1 is in center sprung mode, the drone can be configured to automatically maintain its present altitude. The drone may be configured to maintain his present altitude by utilizing a barometric pressure sensor and/or any other suitable altitude sensor to determine its present altitude and automatically operate its motors to maintain that altitude. User manipulations of the joystick associated with channel 1 can then cause the drone to incrementally increase or decrease its altitude. For example, if a user pushes the joystick 100 forward from the centered position, the drone can be configured to increase its altitude. If the user then releases the joystick 100, allowing the joystick to return to its center position, the drone can be configured to maintain this new increased altitude. If the user then pulls the joystick 100 backward from the center position, the drone can be configured to decrease its altitude. If the user then releases the joystick 100, allowing the joystick to return to its center position, the drone can be configured to maintain this new decreased altitude.

By allowing a user to issue incremental altitude commands to the drone, a beginning drone pilot can more easily focus on learning to control the other flight characteristics of the drone without having to simultaneously learn to control a throttle level of the drone. With embodiments of remote control devices disclosed herein, however, once the drone pilot is more experience, the center sprung channel can be switched back to a non-sprung mode, enabling full control of throttle by the user.

In some embodiments, when channel one is in a center sprung mode, the gimbal of the joystick comprises at least two laterally protruding members that engage a rotatable arm or rocker arm that is biased against the laterally protruding members (e.g., by a spring or other resilient member). This bias maintains the gimbal in equilibrium at the centered position, until an external force on the joystick overcomes the biasing force. When the joystick is moved away from the centered position, at least one of the at least two laterally protruding members overcomes the biasing force of the rotatable arm, causing the rotatable arm to rotate. When the user releases the joystick, the biasing force of the rotatable arm causes the rotatable arm to press against the at least one of the at least two laterally protruding members, thus returning the joystick to the equilibrium centered position. Some embodiments comprise a toggle, switch, lever, and/or the like that allows the user to switch this channel from a center sprung mode to a non-sprung mode. When the toggle, switch, lever, and/or the like is manipulated by the user, this causes the rotatable arm to be rotated against its biasing force out of engagement with the at least two laterally protruding members of the gimbal. The gimbal can then be free to rotate and remain at a non-centered position, without the rotatable arm forcing the joystick back to the centered position.

In some embodiments, when a joystick channel is switched from center sprung to a non-sprung mode, it can be desirable to also introduce or increase a friction force that resists rotation of the joystick about that channel's axis. For example, if there is no or relatively little friction resisting rotation of the joystick about that axis, when the joystick switches from center sprung to non-sprung mode, the joystick may freely move about that axis or could be caused to move with a bump of the remote controller, which may lead to undesirable or unpredictable results. Accordingly, another benefit of embodiments disclosed herein is that the toggle, switch, lever, and/or the like that causes the rotatable arm to be moved out of engagement with the laterally protruding members can also cause a friction member to simultaneously engage a portion of the gimbal to add a frictional force (or to engage the gimbal with additional force, to increase an already present frictional force). For example, a second rotatable arm, leaf spring, and/or other friction member can be configured to be biased against a friction surface of the gimbal (for example, an arc- or drum-shaped surface) to generate a friction force between the friction member and the friction surface of the gimbal. When the toggle, switch, lever, and/or the like is in the center sprung mode, the toggle, switch, lever, and/or the like can be configured to force this friction member out of engagement with the friction surface (or to reduce a pressure of the friction member on the friction surface). When the toggle, switch, lever, and/or the like is in the non-sprung mode, however, the toggle, switch, lever, and/or the like can be configured to allow the friction member to engage the friction surface (or to increase a pressure of the friction member on the friction surface).

In some embodiments, in addition to the remote control unit being configured to enable a mechanical change of the joystick from center sprung to non-sprung modes and vice versa, the remote control unit can also be configured to electronically detect which mode the joystick is presently in. This can be beneficial, because, as mentioned above, it may be desirable to map the user input on this channel to a different flight control channel or characteristic depending on the mode the joystick is in. For example, in non-sprung mode, channel 1 may be mapped to absolute throttle, and in center sprung mode, channel 1 may be mapped to incremental altitude. With a remote control unit as disclosed herein that is capable of electronically detecting which mode the joystick is in, the remote control unit can effectuate such changes in mapping of the user input channel to flight control data. In some embodiments, a single toggle, switch, lever, and/or the like manipulates the rotatable arm that switches the channel between center-sprung and non-sprung modes, manipulates the friction member to engage or disengage the friction surface, and manipulates an electronic switch to indicate to the controller of the remote control unit what mode the channel is currently in. In some embodiments, a separate component manipulates one or more of these features.

Various embodiments can implement the changes in mapping of the user input channel to flight control data in various ways. For example, in some embodiments, the remote control unit can be configured to transmit data to the drone that indicate to the drone which control mode the joystick is currently in. The drone can then be configured to adjust its response to user inputs related to the appropriate channel based on the present mode the joystick is in. For example, if the remote control unit indicates to the drone that channel one is presently in the center sprung mode, the drone can be configured to activate its barometric pressure sensor and/or to use data from its barometric pressure sensor to automatically control the motors of the drone to maintain a particular altitude. If the remote control unit indicates to the drone that channel one is presently in the non-sprung mode, the drone can be configured to deactivate its barometric pressure sensor and/or to discontinue automatically maintaining an altitude of the drone.

In some embodiments, the data transmitted from the remote control unit to the drone indicating a present orientation of the joystick of channel 1 can be the same or similar regardless of the mode that channel one is presently in. In such a case, the drone can use the indication from the remote control unit as to what mode the joystick is presently in to change the drone's operation in response to the channel one user inputs. In some embodiments, the data transmitted from the remote control unit to the drone indicating a present orientation of the joystick of channel one can be different depending on which mode channel one is presently in. For example, the remote control unit may be configured to, in non-sprung mode, transmit data to the drone indicating a present orientation of the joystick on a scale from zero to some positive maximum value. The remote control unit may also be configured to, in the center sprung mode, transmit data to the drone indicating a present orientation of the joystick on a scale of a minimum negative value to a maximum positive value, the scale being centered on zero. Even in such an embodiment, the remote control unit can still be configured to transmit data to the drone indicating which mode the joystick is presently in, such as to enable the drone to know whether to operate in a mode that maintains a present altitude or not.

Although the present disclosure refers in various places to a remote control unit having a single input channel switchable between center sprung and non-sprung modes, with that channel being associated with channel 1, the concepts disclosed herein can be used to create remote control units having different channels switchable between center sprung and non-sprung modes, and/or with remote control units having more than one channel switchable between center sprung a non-sprung modes.

Some users of drones may prefer a stick that is center-sprung in all directions, while other users prefer a stick that is non-sprung in the forward and backward direction (and/or another direction). As mentioned above, a drone remote control unit having a center-sprung lever arm or joystick in channel 1 (or another channel associated with throttle and/or altitude of the drone) can control a drone having a barometric pressure sensor (or other altitude sensor) for maintaining the altitude of the drone above the ground. The barometric pressure sensor (or other altitude sensor) can also allow the drone to perform an auto-start (e.g., the drone can automatically take off from the ground and go into a hover at a predetermined altitude). Novice drone flyers may prefer the center-sprung styled lever arm. However, having the barometric pressure sensor activated may in some cases limit the drone's angle of inclination and/or make it less agile at performing stunts. Accordingly, a more experienced drone flyer may prefer the non-sprung styled lever arm. The embodiments disclosed herein can provide selectable center sprung and non-sprung joysticks to accommodate both types of users and/or multiple flight modes.

### Example Center-Sprung/Non-Sprung Dual Mode Gimbals

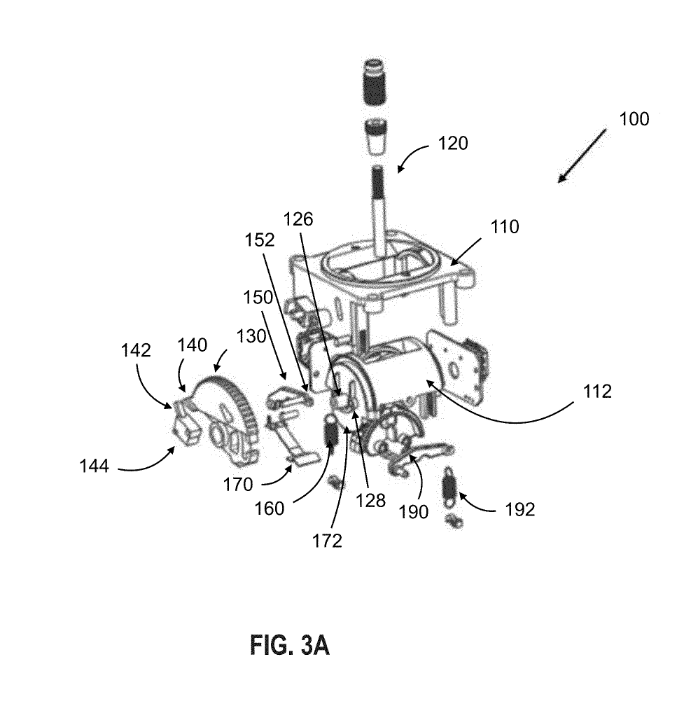

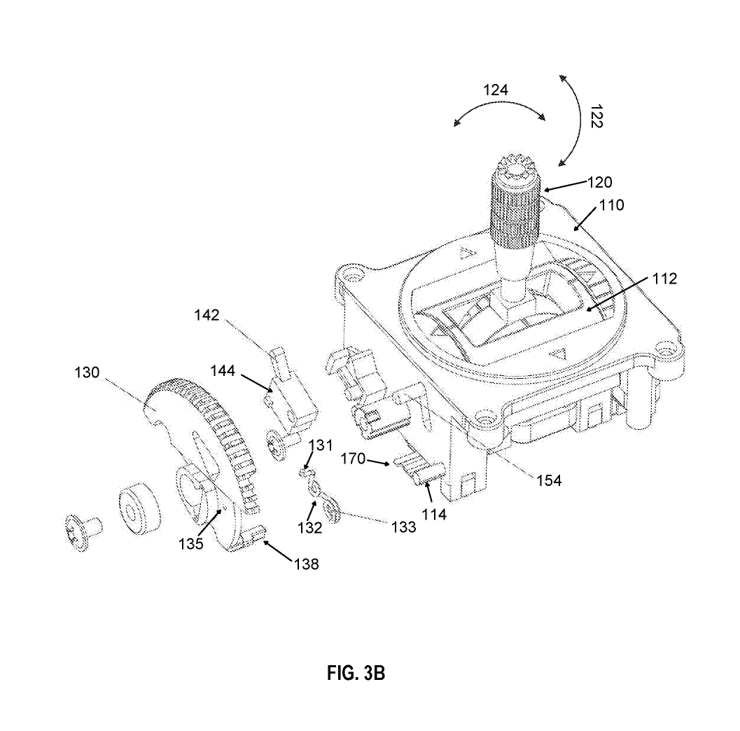

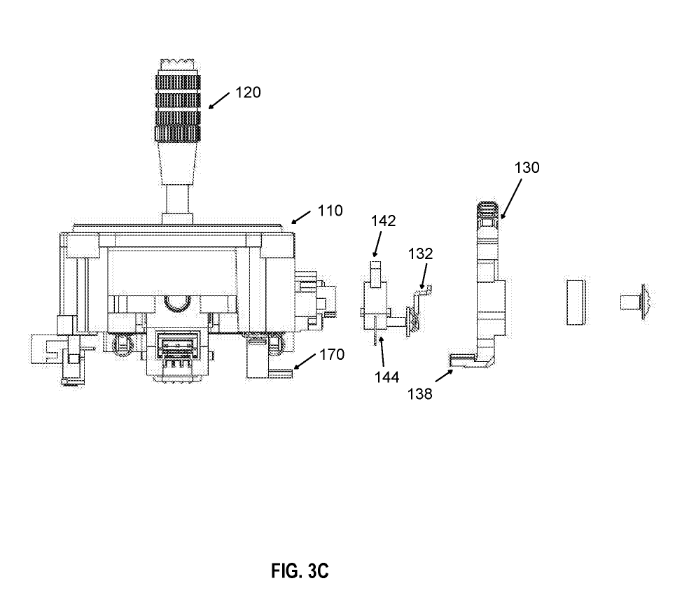

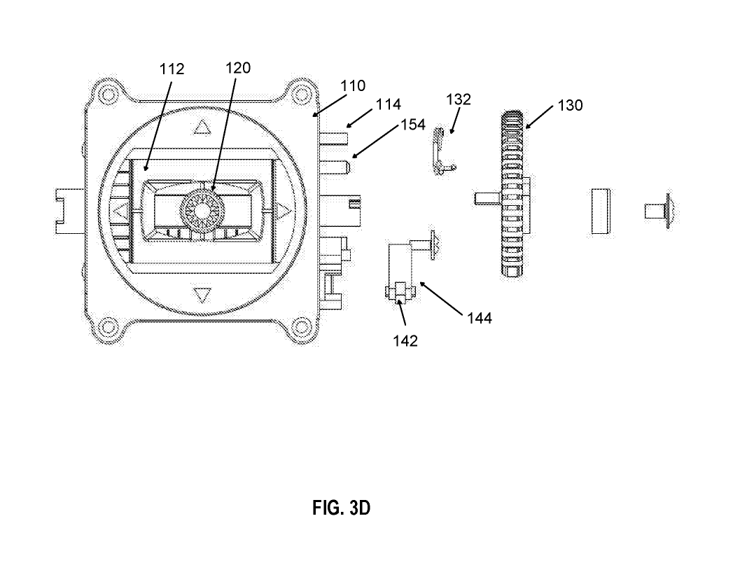

FIGS. 3A-D illustrate an embodiment of the first gimbal 100. The first gimbal 100 can allow the user to select between a center-sprung and a non-sprung mode using toggle 130 (further described below). The first gimbal 100 can include an outer housing 110, a rotatable drum 112, and a lever arm (also known as a joystick) 120. The outer housing 110 can be stationary during use of the remote control unit 10. The outer housing 110 can house the rotatable drum 112. The outer housing 110 and the rotatable drum 112 can each have an opening from which the lever arm 120 can extend away from the outer housing 110 and the rotatable drum 112. The rotatable drum 112 can house a pivoted support configured to allow a two-axis rotation. The pivoted support can be coupled to the lever arm 120, and can restrict movements of the lever arm 120 in a first direction 122 about a first axis and a second direction 124 about a second axis. The first direction 122 is orthogonal to the second direction 124. Rotation of the lever arm 120 in the first direction 122 can cause the rotatable drum 112 to move in unison with the lever arm 120 in the first direction 122. Component 112 is referred to herein as a drum, because it comprises a partially drum- or cylindrically-shaped surface. Such a surface shape can be desirable, for example, because as the joystick rotates, the drum or cylindrically shaped surface will keep the opening in the housing of the remote control unit 10 through which the joystick protrudes substantially protected from ingestion of external debris. The concepts disclosed herein are not limited to use with a design having a drum or cylindrically shaped surface, however. For example, in some embodiments, a remote control unit may comprise a flexible material such as plastic or rubber that helps to prevent external debris from entering the housing of the remote control unit 10, and the portion referred to herein as the drum 112 may not necessarily be drum shaped or cylindrically shaped.

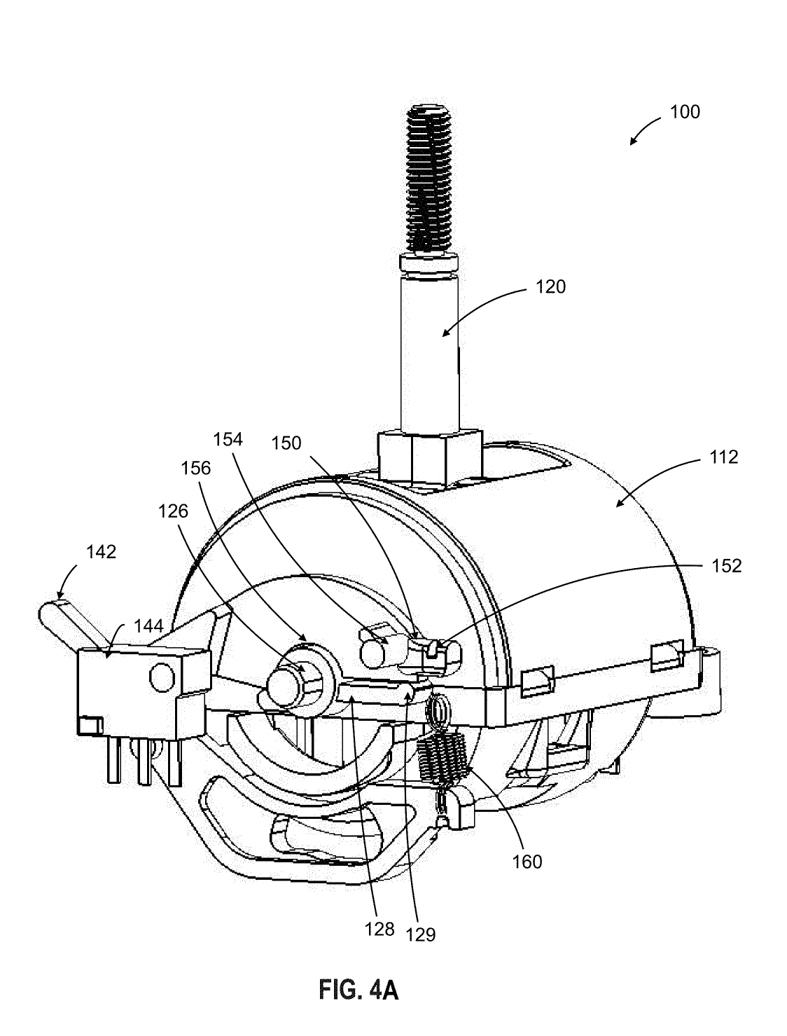

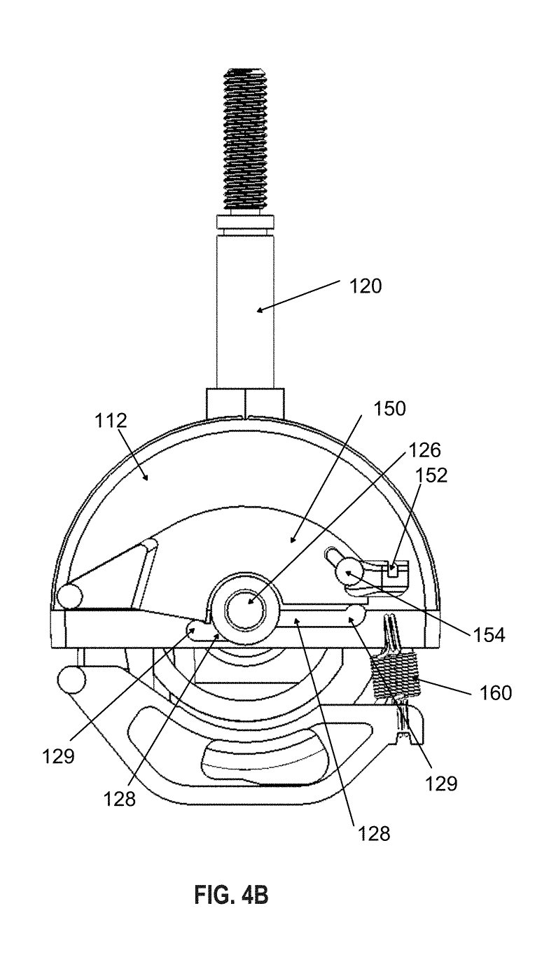

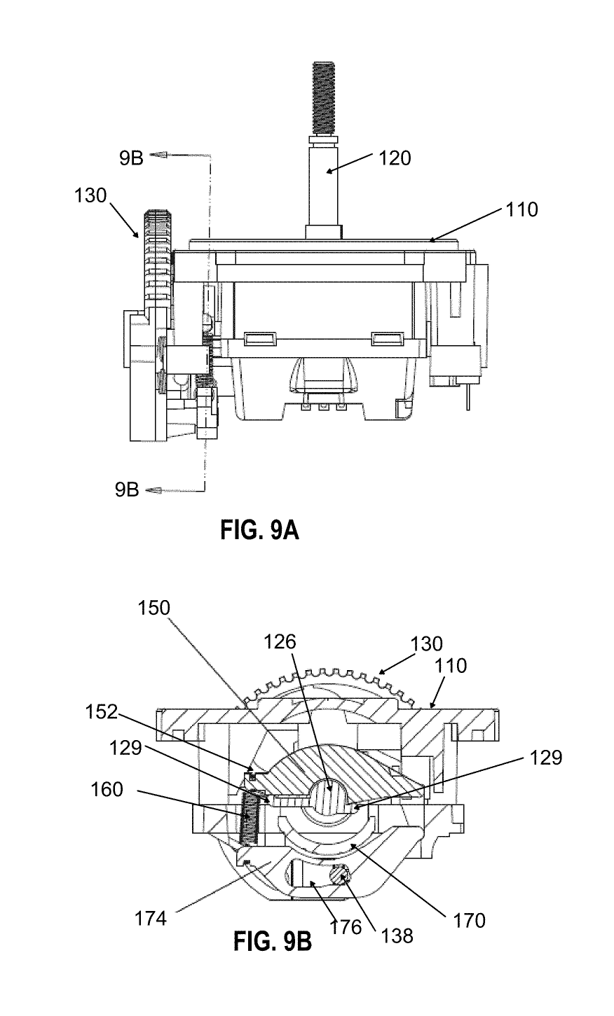

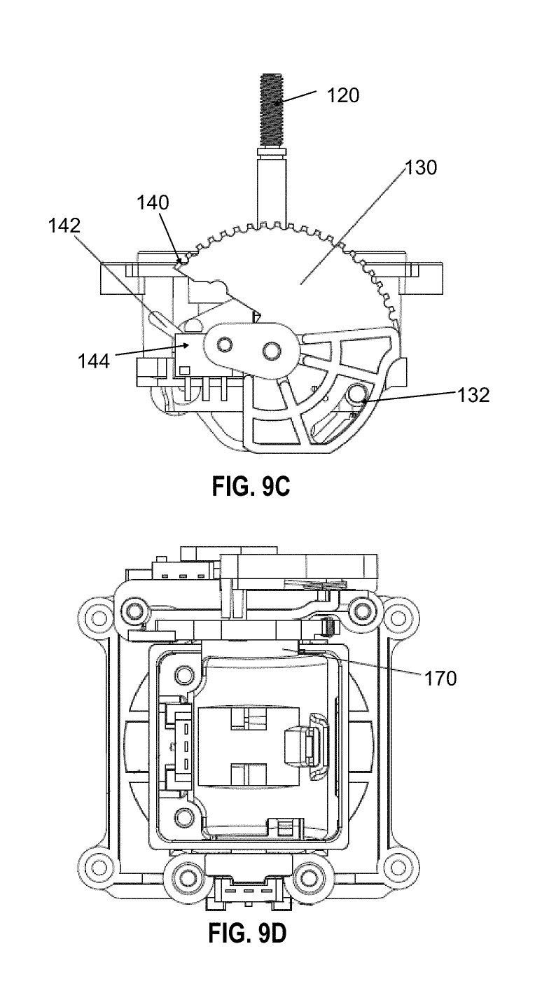

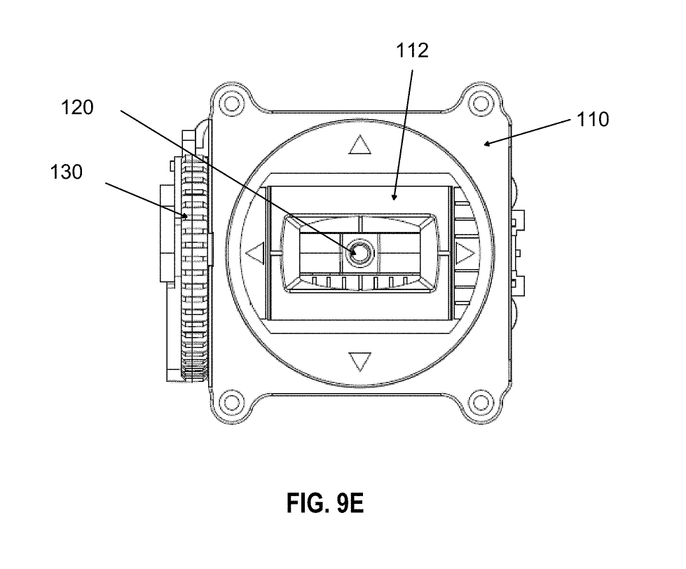

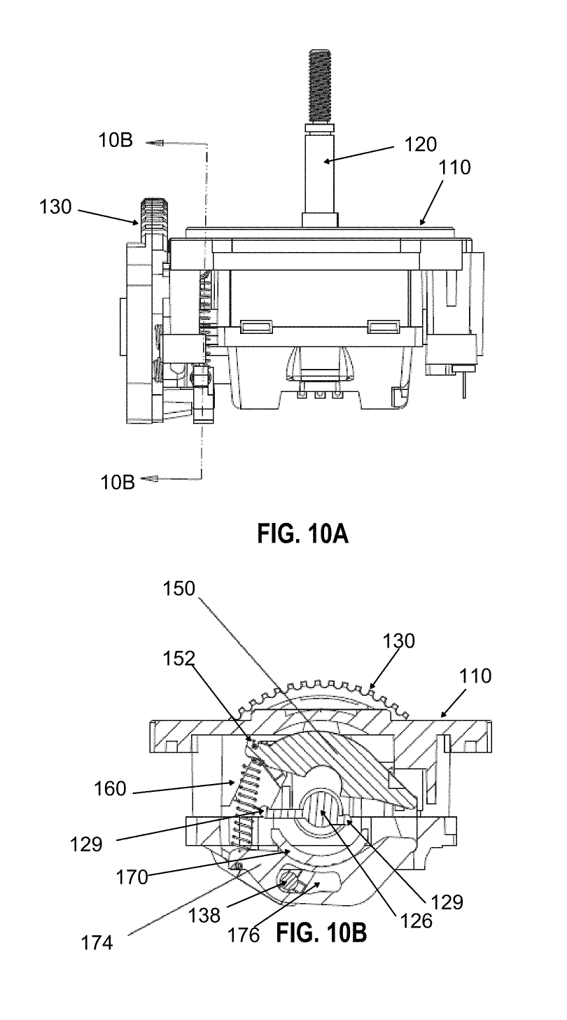

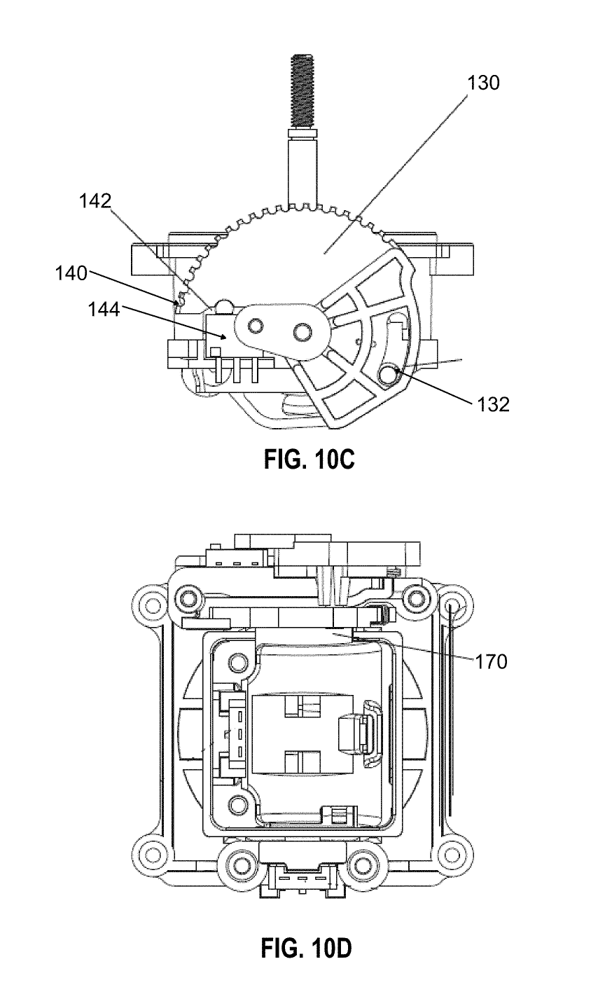

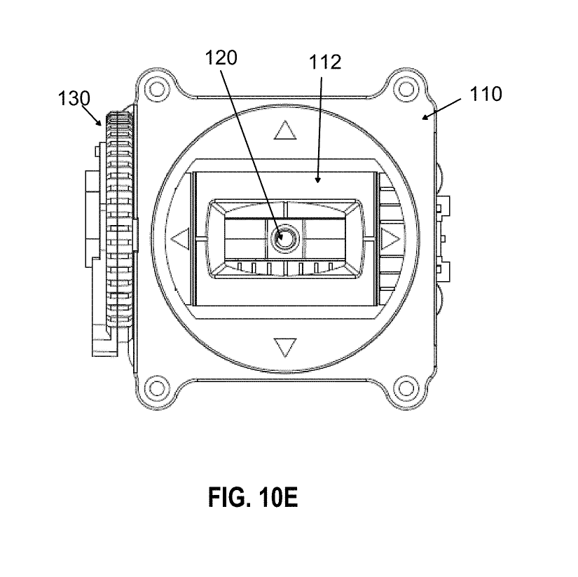

Mode switch of the first gimbal 100 between the center-sprung and the non-sprung modes will be described with reference to FIGS. 4A-B. The lever arm 120 can be coupled to an axle 126 that is substantially coaxial with the rotatable drum 112 and extends out of an end surface of the drum 122. A bar 128 can be centrally pivoted at the axle 126. The bar 128 can run generally perpendicular to the axle 126 and generally parallel to the first direction 122. The bar 128 can be attached to the rotatable drum 112, or be an integral part of the rotatable drum 112 that laterally protrude from the end surface of the rotatable drum 112. The bar 128 can have an optional protrusion 129 (for example, a laterally protruding member) protruding in a direction substantially perpendicular to a length of the bar 128 on or near each end of the bar 128 along its length. In some embodiments, instead of a single bar 128 being pivoted at the axle 126, two separate bars can each extend from the axle 126, one on either side. Further, instead of using bars 128, other laterally protruding members, such as shafts, pins, and/or the like may be used. As shown in FIG. 4A-B, the first gimbal 100 can further include a rotatable arm, rotatable member, or rocker arm 150 located adjacent the end surface of the rotatable drum 112. The rocker arm can include a groove 152 at a first end of the rocker arm 150. Although not shown in FIGS. 4A-B, the groove 152 can engage one end of a spring 160 (FIGS. 9B and 10B illustrate the groove 152 engaging the one end of the spring 160). Another end of the spring 160, opposite the one end, can be fixed to the outer housing 110 or another stationary location of the first gimbal 100. In some embodiments, the other end of the spring 160 can be connected to another rotatable arm, which will be described in greater detail below in FIGS. 9B and 10B. A second end of the rocker arm 150, opposite the first end, can be pivoted at or near a circumference of the rotatable drum 112 (or elsewhere). The pivot of the rocker arm 150 can be on an inner wall of the outer housing 110, or other stationary locations of the first gimbal 110. When the rocker arm 150 pivotally rotates about its second end, a tensile force can be exerted on the spring 160, causing the spring 160 to extend or shorten its length, causing the rotatable arm to be biased toward the laterally protruding members (biased in a clockwise direction as shown in FIGS. 4A-B). Although this embodiment utilizes a tension spring 160 to bias the rotatable member 150, other embodiments may use a compression spring or torsional spring to bias the rotatable member.

As shown in FIGS. 4A-B, the rocker arm 150 can have a cut-out portion 156 near a middle portion of the rocker arm 150. The cut-out portion 156 can be complementary to and accommodate the axle 126. A free length of the spring 160 can be selected such that the cut-out portion 156 is close to or contacts the axle 126 when the spring 160 is substantially at its free length or extended a little longer than its free length to have some tension preload. The lever arm 120 can be at a central position when the spring 160 is substantially at its free length or extended a little longer than its free length. The bar 128 or the optional protrusions 129 can engage or contact the rocker arm 150 along at least a portion of a length of the rocker arm 150 throughout a range of motion of the lever arm 120 when the spring 160 varies in its length. A force causing rotation of the lever arm 120 in the first direction 122 can cause the bar 128 to move in a see-saw manner, which can in turn cause the rocker arm 150 to rotate about its second end. As described above, the rotation of the rocker arm 150 can exert a tensile or compressive force on the spring 160, causing the spring 160 to lengthen or shorten its length. When the force causing rotation of the lever arm 120 is removed, such as when the user releases her hand from the lever arm 120, the spring 160 can return to its length when the lever arm 120 is in the center position, thereby returning the lever arm 120 to the center position.

As described above, in the center-sprung mode, the spring 160 may be allowed to return to its free length when lengthened or shortened (or at least to return to a shorter length, with some tension preload still present). In the non-sprung mode, the spring 160 cannot return to its free length or at least to a shorter length. Specifically, the rocker arm 150 can further include a pin 154 (or other protruding member) at or near its first end. The pin 154 can extend generally perpendicular to the length of the rocker arm 150 and away from the end surface of the rotatable drum 112. In the non-sprung mode, the pin 154 is pushed to lengthen the spring 160 and maintained at that location (desirably by the toggle 130, which will be described in greater details below) such that the bar 128 or the optional protrusions 129 no longer can contact the rocker arm 150 even when the lever arm 120 is rotated to its limits in the first direction 122. The groove 156 is not near or touching the axle 126 in this mode.

With continued reference to FIG. 4A, the first gimbal 100 can optionally be configured to electronically detect which mode the gimbal is in, so that a controller of the remote control unit can inform the drone about the present mode. Upon receiving data from the remote control unit about the present mode, the drone can adjust its operation in a variety of ways. For example, the drone can activate or deactivate the barometric pressure sensor based on the mode of the first gimbal 100. The drone can activate or deactivate or changes modes of operation of other sensors and/or motors on the drone in response to the mode change of the remote control unit. As shown in FIGS. 3A and 4A, the first gimbal 100 can include a switch 144. The switch 144 can be a barometric pressure sensor switch or switches for other sensors/motors. When switch 144 is referred to herein as a barometric pressure sensor switch, this means the switch is intended to cause activation or deactivation of a barometric pressure sensor of the drone. The switch 144 can take various forms (e.g., toggle, button, magnetic sensor, optical sensor, and/or the like), and be positioned in various locations, as long as the switch is capable of detecting that the gimbal has changed modes. As will be described in greater details below, the first gimbal 100 can be configured to activate the switch 144 in the center-sprung mode (e.g., by movement of toggle 130), and be configured to deactivate the switch 144 in the non-sprung mode (e.g., by movement of toggle 130). In other embodiments, the first gimbal 100 can be configured to deactivate the switch 144 in the center-sprung mode and activate the switch 144 in the non-sprung mode. The switch 144 can communicate with a controller of the remote control unit 10, which can transmit data wirelessly to the drone in response to activating or deactivating the switch 144. Upon receiving the transmitted data, the drone can activate or deactivate one or more sensors and/or motors on the drone.

### Example Mode Switch Toggle

Example Mode Lock Assembly

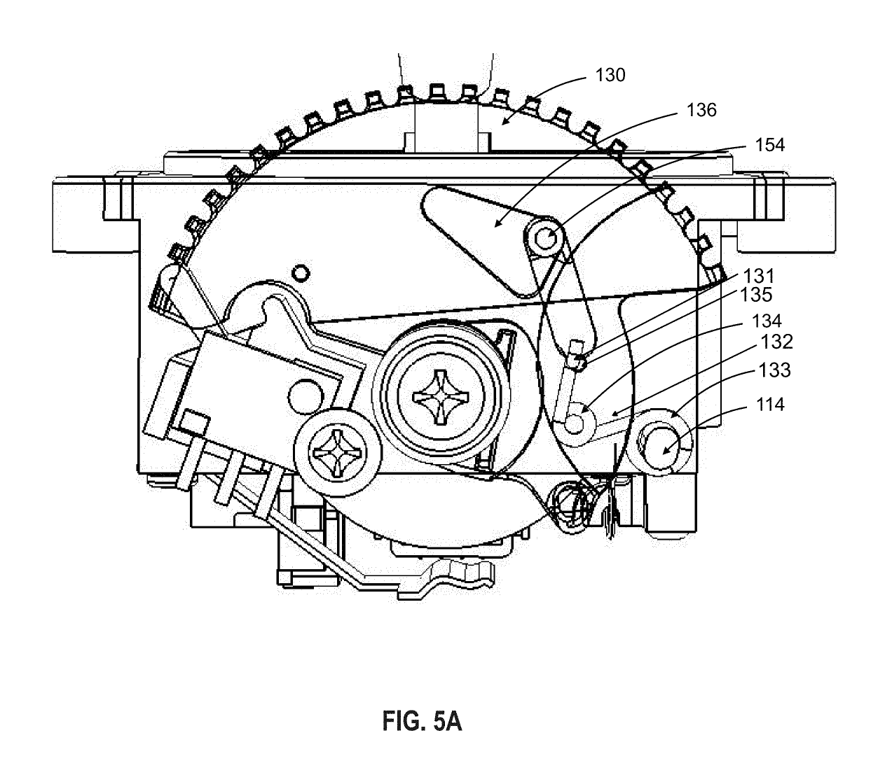

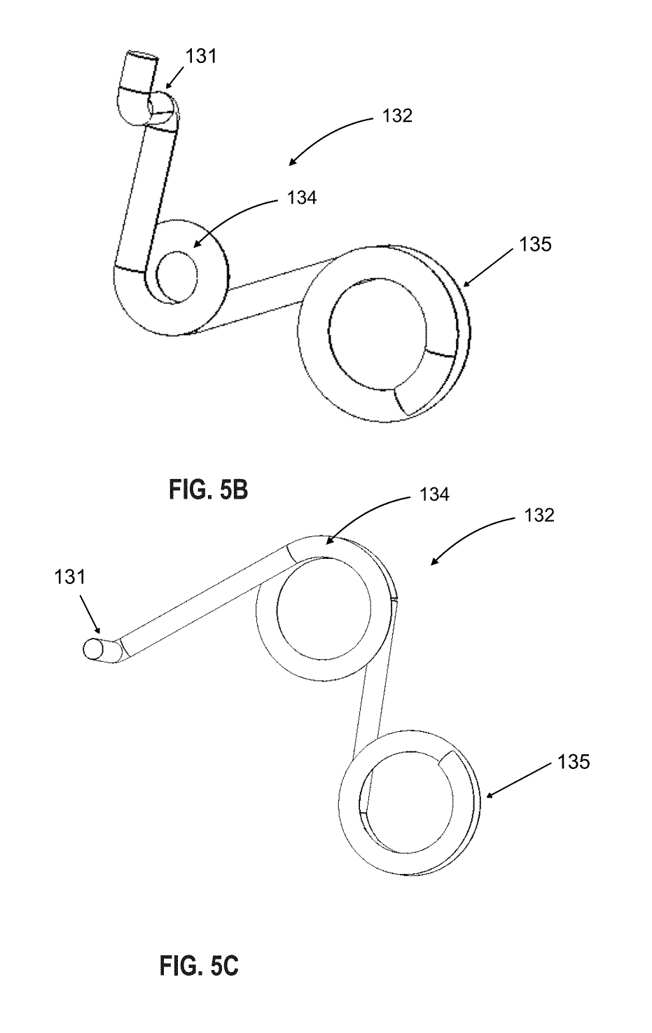

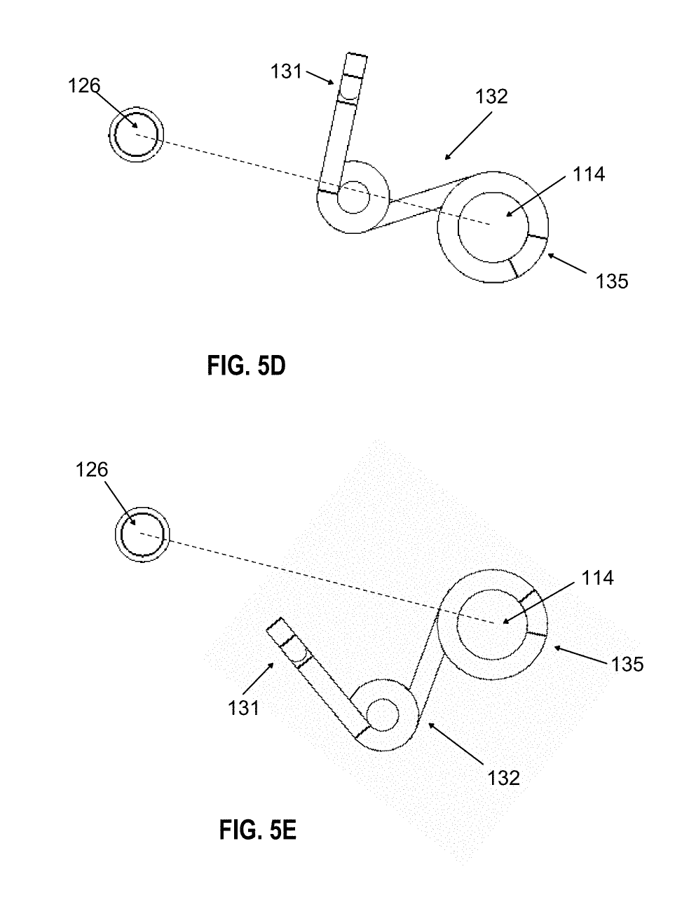

Turning to FIG. 5A, a user can switch the first gimbal 100 between the center-sprung and non-sprung modes by manipulating a toggle 130. The toggle 130 can move between a first position and a second position. When the toggle is in the first position, the first gimbal 100 can be in the center-sprung mode. When the toggle is in the second position, such as shown in FIG. 5A, the first gimbal 100 can be in the non-sprung mode. Although the toggle 130 is illustrated as a thumb wheel mounted on the axle 126, the toggle can be any other rotational element. The toggle can also follow a translational motion (for example, a pushbutton or slider), such as a rectilinear motion, when transiting between the center-sprung and non-sprung modes.

FIGS. 5A and 5C-D further illustrate a mode locking mechanism. The mode locking mechanism can include a torsional spring 132. The torsional spring 132 can have a first end 131 and a second end 133. The first end of the torsional spring 132 can be attached to the thumb wheel 130 at a location 135. The second end 133 of the torsional spring 132 can be mounted on a post 114 on an outer wall of the outer housing 110. The torsional spring can rotate about the post 114. The torsional spring 132 can have a first position and a second position. The torsional spring 132 can bias the thumb wheel 130 into its first position when the torsional spring 132 is in the first position, as illustrated in FIG. 5D, and bias the thumb wheel 130 into its second position when the torsional spring 132 is in the second position, as illustrated in FIG. 5E. In some embodiments, such as shown in FIG. 5D, the torsional spring 132 in the first position can bias the thumb wheel 130 in a counterclockwise direction. The first end 131 of the torsional spring 132 is located above a line formed between the pivot centers, 114, 126 of the torsional spring 132 and the thumb wheel 130, respectively. In some embodiments, such as shown in FIG. 5E, the torsional spring 132 in the second position can bias the thumb wheel 130 in a clockwise direction. The first end 131 of the torsional spring 132 is located below the line formed between the pivot centers, 114, 126 of the torsional spring 132 and the thumb wheel 130, respectively.

FIG. 5B illustrates one embodiment of the torsional spring 132 with an intermediate coil 134 extending in one direction. FIG. 5C illustrates another embodiment of the torsional spring 132 with the intermediate coil 134 extending in a direction that is generally opposite the direction of the intermediate coil 134 in FIG. 5C. Other mode locking mechanisms can be used, such as a compression spring, a cam, snap fit hook or tabs, any detent mechanisms, and the like.

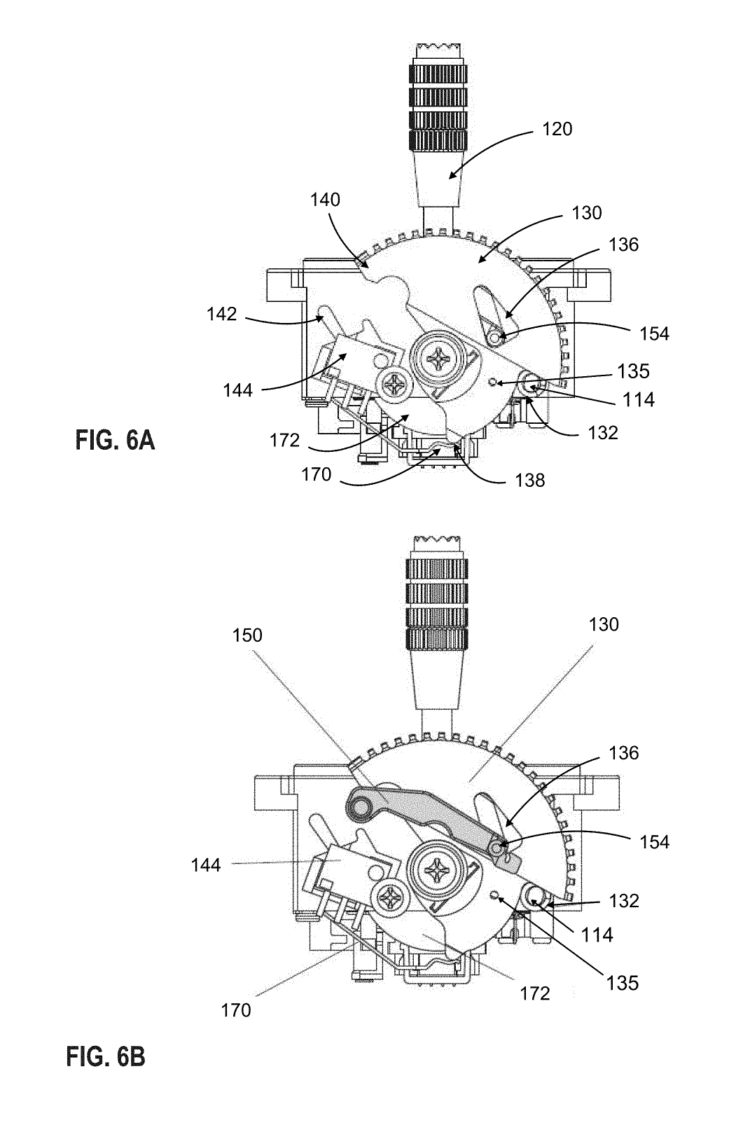

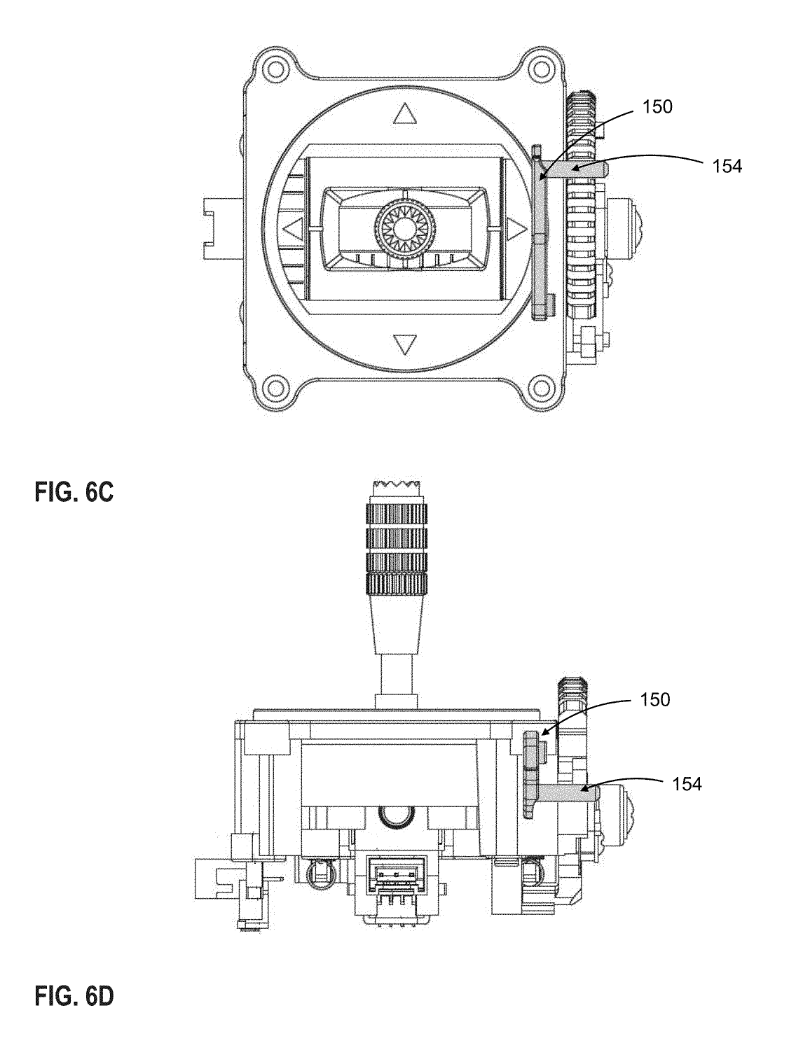

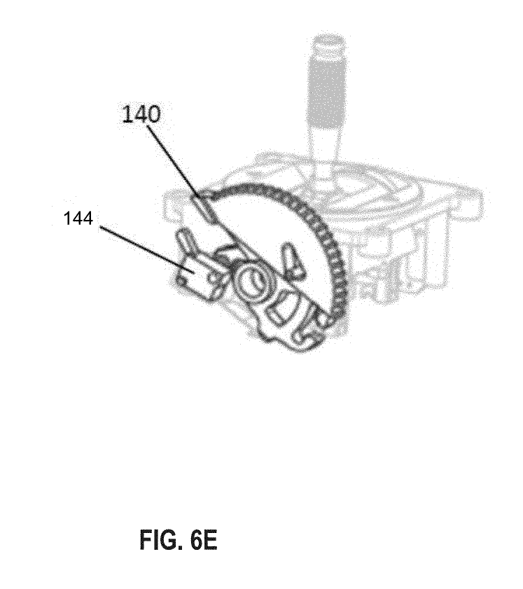

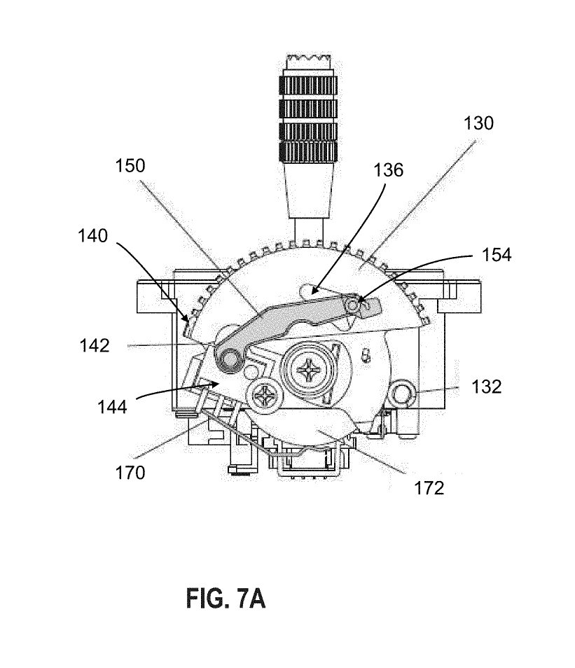

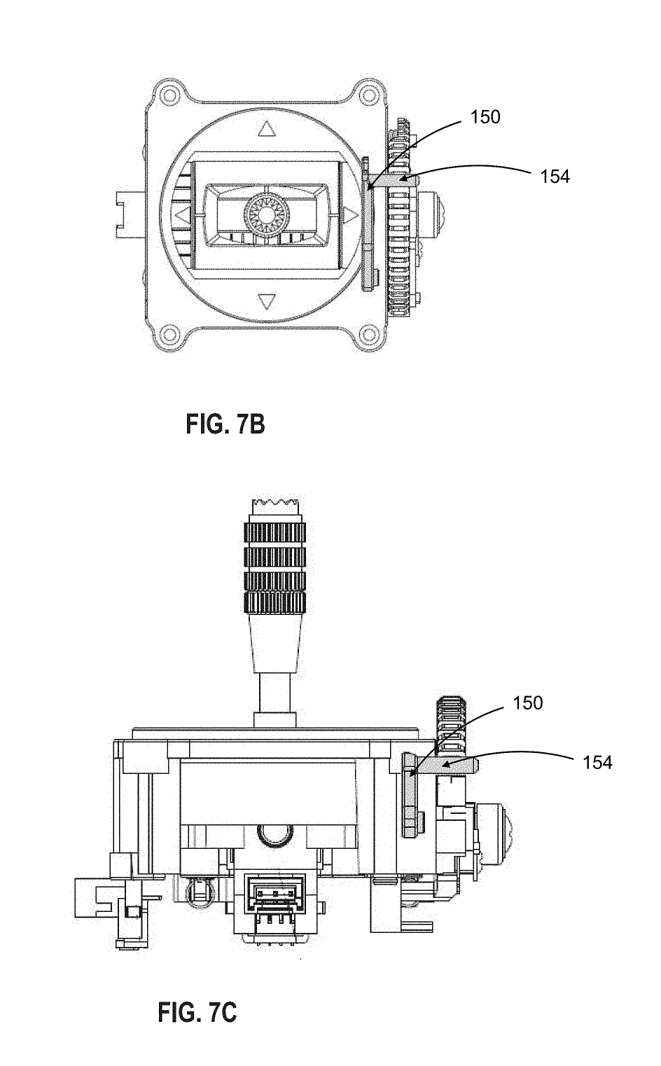

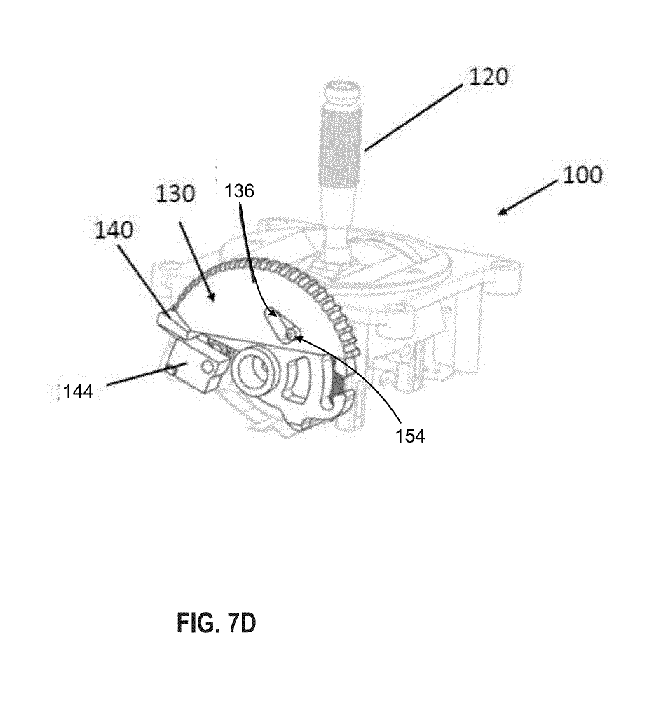

Additional details of the first gimbal 100 toggling between the center-sprung mode and the non-sprung mode will now be described with reference to FIGS. 6A-E (center-sprung mode) and FIGS. 7A-D (non-sprung mode). In FIGS. 6B-D and 7A-C, the rocker arm 150, which should be hidden behind the outer housing 110, is shown for clarity.

Example Center-Sprung Mode

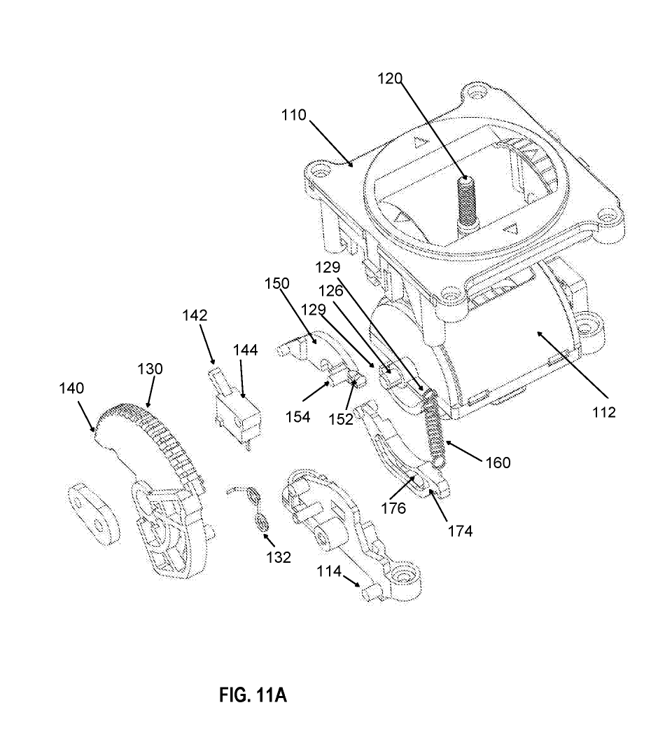

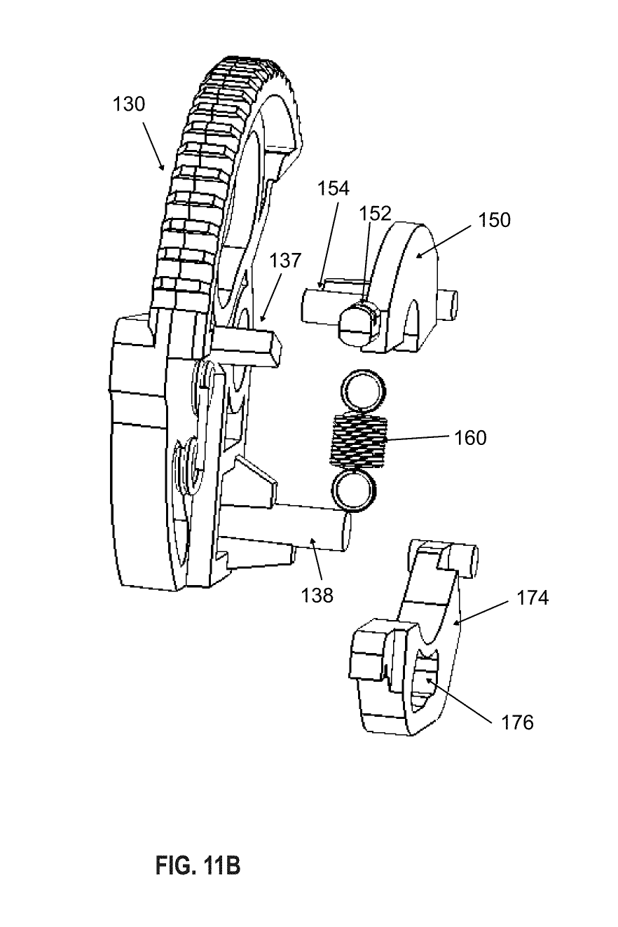

As shown in FIGS. 6A-E, the thumb wheel 130 is in a first position (rotated clockwise with reference to FIG. 6A) when the first gimbal 100 is in the center-sprung mode. The thumb wheel 130 can have a guide track or clearance slot 136. The pin 154 of the rocker arm 150 can be sized to move freely along the guide track 136 (or within the slot 136). In the center-sprung mode, the pin 154 can be at a first location, as shown in FIG. 6D. The rocker arm 150 can be in contact with the bar 128 or the optional protrusions 129 and the spring 160 can be at substantially its free length (or at least a shorter length than when the arm 150 is rotated counterclockwise by movement of the joystick or toggle 130) when the lever arm 120 is substantially at the center position. Rotating the lever arm 120 in the first direction 122 (i.e. clockwise or counterclockwise with reference to the orientation of FIG. 6A) can exert a tensile force on the spring 160. Because a laterally extending protruding member (for example, protrusions 129) contacts the lever arm 120 on either side of the axle 126, the lever arm 120 will be caused to rotate counterclockwise whenever the joystick is rotated away from its centered position, regardless of whether the joystick 120 is rotated clockwise or counterclockwise. The pin 154 can move freely along the guide track or clearance slot 136 as the lever arm 120 is rotated in the first direction 122. When the tensile or compressive force is released by releasing the lever arm 120, the spring 160 can return to its free length (or at least a shorter length than when the arm 150 is rotated counterclockwise by movement of the joystick or toggle 130) and cause the lever arm 120 to spring back to the center position. In some embodiments, the thumb wheel 130 may not have a clearance slot 136 to accommodate the pin 154. For example, as shown in FIG. 11B, the thumb wheel can have a protrusion 137 (e.g., laterally protruding member, pin, shaft, and/or the like) protruding toward the rocker arm 150 to engage the pin 154 and push the pin 154 into the second location. In other embodiments, a stepped feature, or a closed-end guide or clearance slot on a surface of the thumb wheel 130 facing the rocker arm 150, or the like, can push the pin 154 into the second location.

As described above, the lever arm 120 can be center-sprung in the second direction 124. The first gimbal 100 can optionally include a second rocker arm 190 (shown in FIG. 3A). One end of the second rocker arm can be coupled to a second spring 192 (shown in FIG. 3A). The second rocker arm 190 can be pivoted at another end of the second rocker arm 190 opposite the one end. Rotation of the lever arm 120 in the second direction 122 can cause the second rocker arm 190 to rotate about the other end, thereby exerting a tensile or compressive force on the second spring 192. When the lever arm 120 is released, for example, from a user's hand, the lever arm 120 can spring back to the central position by the second spring 192 in a similar manner as the spring 160 in the center-sprung mode as described above.

The thumb wheel 130 can optionally engage or disengage the switch 144 in the center-sprung and non-sprung modes, respectively. Specifically, the thumb wheel 130 can include an extension 140 (or any other surface configured to contact the switch 144) at one end of the thumb wheel 130. Location of the extension 140 is not limiting. The switch 144 can have a corresponding tab 142 (such as a toggle arm of a toggle switch, a contact surface of a pushbutton, and/or the like). The tab 142 can be configured to be spring-biased or otherwise positioned in an activation position. In other embodiments, the tab 142 can be configured to be spring-biased or otherwise positioned in a deactivation position. In the center-sprung mode, the extension 140 of the thumb wheel 130 can be away from and not contacting the tab 142, as shown in FIG. 6A. The switch 144 can communicate with a controller of the remote control unit 10 (which will be described in greater details below), so that the controller can send data about a status of the switch 144, such as a mode switch from center-sprung to non-sprung or vice versa, to the drone. In some embodiments, the tab 142 and/or the switch 144 can be separately or independently controlled rather than being controlled by the extension 140 of the thumb wheel 130.

Example Non-Sprung Mode

Turning to FIGS. 7A-D, the thumb wheel 130 is in a second position (rotated counter-clockwise with reference to FIG. 7A) when the first gimbal 100 is in the non-sprung mode. The pin 154 can be at a second location as shown in FIG. 7C (resulting in the rocker arm 150 rotating counter-clockwise with reference to FIG. 7A) and maintained at the second location because the torsional spring 132 is biased in the second position (thus maintaining the toggle or thumb wheel 130 in the second position). The rocker arm 150 is no longer in contact with the bar 128 or the optional protrusions 129 throughout the range of motion of the lever arm 120. The spring 160 is maintained at an extended length throughout the range of motion of the lever arm 120. The pin can be pushed to an end of the guide track or clearance slot 136 and does not move when the lever arm 120 is rotated in the first direction 122. In this mode, the lever arm 120 can still be center-sprung in the second direction 124 as described above.

The thumb wheel 130 can optionally engage the switch 144 in the non-sprung mode. Specifically, the extension 140 of the thumb wheel 130 can contact or engage the tab 142 of the switch 144. The tab 142 can be pushed into the deactivation mode by the extension 140 rotating the tab 142 into the deactivation mode. In some embodiments, the tab 142 can be stationary and contact with the extension 140 can electronically deactivate the switch 144. In other embodiments, contact between the tab 142 and the extension 140 can mechanically or electronically activate the switch. The switch 144 can communicate with a controller of the remote control unit 10 (which will be described in greater details below), so that the controller can send data about the status of the switch 144 to the drone.

Example Friction Assemblies in the Non-Sprung Mode

As shown in FIG. 7A, the first gimbal 100 can optionally have a friction assembly. In the non-sprung mode, as the lever arm 120 is no longer sprung into the center position, the friction assembly can hold the lever arm 120 stationary in a non-center position after the lever arm 120 has been manipulated in the first direction 122. The friction assembly can include a friction member or leaf spring 170 and a friction wheel 172. The leaf spring 170 can be in contact or bias against a friction surface of the friction wheel 172 in the non-sprung mode. The friction wheel 172 can be coupled to the rotatable drum 112, or be an integral part of the rotatable drum 112, or be coupled to the axle 126, or otherwise operably coupled to the lever am 120. When movement or rotation of the friction wheel 172 is resisted by a friction force between the leaf spring 170 and friction surface of the friction wheel 172, the lever arm 120 remains stationary until an external force, such as from the user's hand, overcomes the friction to move the lever arm 120.

The thumb wheel 130 can include a hook or protrusion 138 extending generally toward the end surface of the rotatable drum 112. The hook or protrusion 138 does not contact the friction wheel 170 in the non-sprung mode. Returning to FIGS. 6A-B, the hook 138 can contact and push the leaf spring 170 away from the friction wheel 172 in the center-sprung mode. The rotatable drum 112 and/or the lever arm 120 can thus freely spring back to the center position in this mode. In some embodiments, the friction member or leaf spring 170 may contact the friction wheel 172 in both non-sprung and center-sprung modes, but the biasing force of the arm 150 generated by the spring 160 may be sufficient to overcome the frictional force of the friction member 170 in center-sprung mode. In some embodiments, the friction member 170 is biased against the friction wheel 172, and the thumb wheel 130 can cause the friction member 170 to be moved away from the friction wheel 172 in the center sprung mode. In some embodiments, the friction member 170 is biased away from the friction wheel 172, and the thumb wheel 130 can cause the friction member 170 to be moved into contact with the friction wheel 172 in the non-sprung mode. In some embodiments, the friction member 170 is always biased to be in contact with the friction wheel 172, but movement of the thumb wheel 130 causes a magnitude of the biasing force of the friction member 170 against the friction wheel 172 to be increased or decreased.

FIGS. 9A-E, 10A-E, and 11 illustrate another example of the first gimbal 100 having a friction assembly without a leaf spring. The friction assembly can include a friction rocker arm 174. The friction rocker arm 174 can have an opening 176 sized and positioned to receive the hook or protrusion 138 of the thumb wheel 130. The spring 160 can be connected at one end to a rotating end of the friction rocker arm 174. The spring 160 can be connected at another end to the rotating end of the rocker arm 150. FIGS. 9A-E illustrate the thumb wheel 130 and the friction rocker arm 174 in the center-sprung mode. In this mode, the laterally protruding members 129 on both sides of the axle 126 can be in contact with the rocker arm 150. The spring 160 can be extended by movements of the lever arm 120 in the first direction (clockwise and counterclockwise with reference to FIGS. 9B and 9C). The lever arm 120 can spring back to the center position after the lever arm 120 has been manipulated to a non-center position in the first direction. In addition, the hook or protrusion 138 of the thumb wheel 130 can push down on the friction rocker arm 174. The friction rocker arm 174 can be out of contact with a friction element, such as the friction wheel 170 described above, or a friction surface or pad of the rotatable drum 112, or the like.

In the non-sprung mode as illustrated in FIGS. 10A-E, the laterally protruding members 129 on both sides of the axle 126 can no longer be in contact with the rocker arm 150 (shown in FIG. 10B). This can be due to the pin or other protrusion member 152 locked in the second position by the torsional spring (shown in FIG. 11A) described above, thereby also maintaining an extended length of the spring 160. The lever arm 120 cannot spring back to the center position after the lever arm 120 has been manipulated to a non-center position in the first direction. In addition, the hook or protrusion 138 can rotate with the thumb wheel 130 such that the hook or protrusion 138 pushes the friction rocker arm 174 into contact and against the friction element, such as the friction wheel 170. The friction between the friction wheel 170 and the friction rocker arm 174 can allow the lever arm 120 to be stationary in a non-center position after the lever arm 120 has been manipulated in the first direction (clockwise and counterclockwise with reference to FIGS. 10B and 10C).

In the embodiment shown in FIGS. 9A-E, 10A-E, and 11, the gimbal 100 can include fewer moving parts and be easier to assemble. Further, rotation of the thumb wheel 130 counterclockwise with reference to FIG. 10C can push the pin 154 of the rocker arm out of contact with the lateral protrusions 129 to allow the gimbal 100 to be in the non-sprung mode, and also push the friction rocker arm 174 into contact and against the friction wheel 170 to provide friction to make the lever arm 120 stationary in its position set by the user. Rotation of the thumb wheel 130 clockwise with reference to FIG. 9C can push the pin 154 of the rocker arm into contact with the lateral protrusions 129 to allow the gimbal 100 to be in the center-sprung mode, and also push the friction rocker arm 174 away from the friction wheel 170 to reduce or remove friction when the lever arm 120 sprung to the center position.

In some embodiments, the friction wheel 172 and the leaf spring 170 can be replaced by other mechanical assemblies that can hold the lever arm 120 stationary in a non-center position. For example, a dowel pin can be inserted against an outer cylindrical surface of the rotatable drum 112 to keep the lever arm 120 stationary in the non-sprung mode. In some embodiments, the hook 138 pushing the leaf spring 170 or the friction rocker arm 174 relative to the friction element can be separately and independently controlled rather than being a portion of the thumb wheel 130.

### System Overview

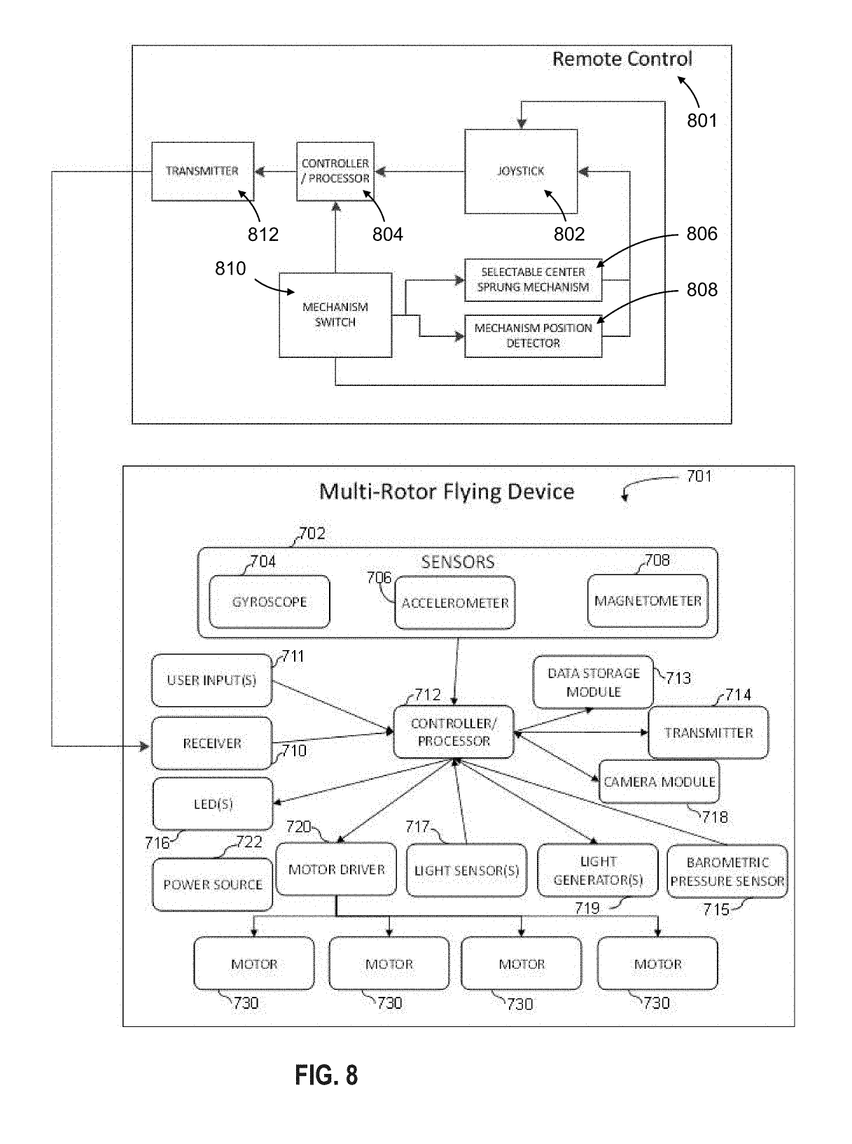

FIG. 8 illustrates an example system block diagram of a drone 701 controlled by a remote control unit 801 described herein. Although this figure presents one embodiment of a flying device, other embodiments of flying devices known in the art (for example, drones, helicopters, airplanes, and the like), and/or their associated remote control units, may be adapted to be used with the techniques disclosed herein.

As described above, the remote control unit described herein can include a joystick or lever arm 802 that is manipulable by a user. The joystick 802 can communicate with a controller/processor 804, such as a hardware processor, of the remote control unit 801, to send user input information to the controller/processor 804. The remote control unit 801 can include a selectable center sprung mechanism 806 and a mechanism position detector 808 that can detect whether the remote control unit 801 is in the center-sprung mode. The remote control unit 801 can include a mechanism switch 810, such as a toggle switch. The user can manipulate the mechanism switch 810 to alternate the selectable center-sprung mechanism 806 between the center-sprung and the non-sprung modes. The mechanism switch 810 and/or the mechanism position detector can inform the controller/processor 804 about a mode switch. The controller/processor 804 can communicate with and send to a data transmitter 812 data relating to, among other commands about the operation of the drone 701, information about a mode switch from the center-sprung mode to the non-sprung mode, or vice versa.

The drone 701 can comprise inertia motion sensors 702; wireless data receiver 710; controller or processor 712; data storage module 713; wireless data transmitter 714; LED(s) 716; camera module 718; light sensor(s) 717; light generator(s) 719; barometric pressure sensor 715, motor driver(s) 720; power source 722; and/or motor(s) 730. In other embodiments, a flying device can comprise fewer, greater, and/or different components. Also, in some embodiments, the flying device can allow for calibration of one or more of its sensors by setting the device on a flat surface and pressing a button on the controller or on the flying device itself, for example. In some embodiments, the flying device can be configured to wirelessly receive data from the remote control unit that indicates the user wishes to recalibrate the gyroscope and/or other sensor of the flying device. This can be responsive to a user input, such as the user pressing a button on the remote control unit or the like. One way such calibration can be implemented is to place the flying device on a flat or substantially flat surface that is oriented parallel or substantially parallel to a horizontal ground plane. Responsive to the user requesting that the flying device calibrate the gyroscope and/or other sensors, the flying device can be configured to recalibrate the gyroscope and/or other sensors based on an assumption that the current resting position of the flying device is parallel to the ground plane. Such functionality can be desirable because a gyroscope and/or other sensors can be inaccurate over time and/or due to impacts on the flying device, and/or the like.

The inertia motion sensors 702 in the drone 701 can comprise at least one or more of a gyroscope 704, accelerometer 706, magnetometer 708, and/or other sensors, such as GPS, thermometer, barometer, altimeter, camera (infrared, visual, and/or otherwise), and/or the like. The gyroscope sensor 704 can allow for the calculation and measurement of orientation and rotation of the drone 701. The accelerometer 706 can allow for the calculation and measurement in acceleration of the drone 701. The magnetometer 708 can allow for the calculation and measurement of magnetic fields and can enable the drone 701 to orient itself in relation to various North, South, East, West directions. The drone can use one or more of the described sensors to be functional and maintain flight. The acceleration and angular velocity, and other data, measured can be used by the drone 701 to assist an operator in flight or record data that may be used for future flights and analysis, or the like. Other sensors may be implemented into the drone 701 to measure and/or record additional statistics such as flight speed, battery level, servo motor position, or other data available through its sensors, internal components, and/or combination(s) of sensors and/or internal components.

The data receiver 710 of the drone 701 can be configured to receive one or more signals from the transmitter 812 of the remote control unit 801. The signal can be sent via wireless radio, infrared wireless, Bluetooth, other wireless communication protocols, wired, and/or the like. The received signal can be sent to the controller or processor 712 of the drone 701 for processing and executing actions based on the received signal. Once the signal is processed, the controller 712 can send commands to the appropriate other components of the drone 701. For example, the controller 712 can perform, among other things, conversion of high level flight control commands from the remote control device into low level motor control commands implement the desired flight control operations. The controller 712 can also receive signal relating to whether the remote control unit 801 is in the center-sprung or non-sprung mode. In response, the controller 712 can command the barometric pressure sensor 715 to be activated if the remote control unit 801 is in the center-sprung mode, and command the barometric pressure sensor 715 to be deactivated if the remote control unit 801 is in the non-sprung mode.

The drone can also allow for users input(s) 711 to control other aspects or components of the system. For example, there can be one or more buttons, switches, microphones (for example, for auditory commands to be received by the user), or the like on the drone 701.

The data storage module 713 can store information and data. The data storage module 713 can comprise read-only memory for the processor 712 to execute previously programmed functions (for example, to turn the LED light on when the drone 701 is powered on). The data storage module 713 can also comprise, instead or in addition, writeable memory to store various programmed functions, data received from the various sensors 702, and/or the like. The data storage module 713 need not contain both types of memory, and may in fact be two or more separate elements optionally implemented. For example, the read-only memory can be incorporated and no other writable memory may be provided. Alternatively, there can be no type of memory installed and any instructions can come directly from a controller. Alternatively, there can be read-only memory installed in the drone 702 and the user may install a physical memory card or chip to store additional information, if the user wishes. The data or information that would get stored in the data storage module 713 can, for example, originate from the component that created the information and go through processing prior to being written to the writable memory.

The transmitter 714 can receive data from the processor to be configured into a signal to send externally to another device, such as a remote control, computer, or remote server for storage and/or analysis. Similar to the received signal through the receive 710 as explained above, the signal sent can be via wireless radio, infrared wireless, Bluetooth, or other wireless communication protocols, wired, and/or the like. Although in this embodiment there are separate components for sending and receiving information (for example, a receiver 710 and a transmitter 714), some embodiments may comprise more than one receiver and/or transmitter, and/or may comprise one or more transceivers, which both receives and transmits signals.

The LED(s) 716 can be installed on the drone in various locations to indicate to the user some information that can be relevant, through color, blinking, or brightness (for example, for indicating the front and the back of the drone 701), and/or for aesthetic reasons.

The camera module 718 can be a device that can be used to generate picture or video data from the drone 701 during flight. The picture or video data can be transmitted via the transmitter 714 to an external device or server or the remote control unit, which can optionally have a receiver, or the data can be stored in the data storage module 713, or both. The camera must send the generated data to the processor 712 first, before the data is sent to the data storage module 713 or transmitter 714.

The motor driver 720 can be configured to receive instructions from the controller 712 and can use the received instructions to control the throttle and speed of the various motors 730 connected to the drone 701. There can be more than one motor driver controlling the motors although only one motor driver is illustrated in FIG. 8. The motor(s) 730 can be connected to the motor driver 720 and receive instructions to operate at various speeds.

The power source 722 can be optionally included in the drone 701 to power one or more components. Each component (for example, processor, camera module, and more) can connect directly or indirectly to the power source 722. This can also be done by connecting some or all devices to a circuit, or motherboard, which can contain the processor 712. The motherboard can be connected to the power source 722. The power source 722 can be a battery (for example, Lithium Ion or Lithium Polymer battery that may be recharged, regular batteries such as AAA or AA, and/or the like), or alternative power provided through other means, such as a wired connection or solar, among others.

In some embodiments, the separate components of FIG. 8 can be combined into fewer components to achieve the same purpose. For example, as stated above, the transmitter 714 and receiver 710 can be combined into one component, such as a transceiver.

Although this disclosure has been disclosed in the context of certain embodiments and examples, it will be understood by those skilled in the art that the present disclosure extends beyond the specifically disclosed embodiments to other alternative embodiments and/or uses of the disclosure and obvious modifications and equivalents thereof. In addition, while a number of variations of the disclosure have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. Accordingly, it should be understood that various features and aspects of the disclosed embodiments can be combined with or substituted for one another in order to form varying modes of the disclosed.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A remote control unit for wirelessly controlling an unmanned flying device, the remote control unit having a user input with selectable center sprung and non-sprung modes, the remote control unit comprising:
a gimbal configured for rotation in a first direction and a second direction, the first direction being substantially perpendicular to the second direction, the gimbal comprising a lever arm configured for manipulation by a user to effectuate rotation in the first and second directions;
at least one spring operably connected to the gimbal and configured to return the lever arm to a center position in the center sprung mode after the lever arm is released from a non-center position in the first direction, wherein the gimbal is operably disconnected from the spring in the non-sprung mode;
a barometric pressure sensor switch comprising activated and deactivated configurations;
a mechanical mode toggle configured to operably connect the gimbal to the spring and activate the barometric pressure sensor switch in the center-sprung mode, and to operably disconnect the gimbal from the spring and deactivate the barometric pressure sensor switch in the non-sprung mode; and
a controller configured to wirelessly communicate with the unmanned flying device, the controller configured to, responsive to detecting activation or deactivation of the barometric pressure sensor switch, transmit data to the unmanned flying device to cause the unmanned flying device to activate or deactivate a barometric pressure sensor.

2. The remote control unit of claim 1, further comprising a rocker arm coupled to one end of the at least one spring, the lever arm being connected to two bars in the first direction with one bar on each side of a center of rotation of the lever arm in the first direction, the bars and the rocker arm being in contact in the center-sprung mode such that rotation of the lever arm throughout a range of motion in the first direction is translated to movements of the rocker arm by at least one of the two bars and exerts a tensile force on the at least one spring, wherein the bars and the rocker arm are not in contact in the non-sprung mode such that rotation of the lever arm throughout the range of motion in the first direction does not exert a tensile force on the at least one spring.

3. The remote control unit of claim 1, further comprising a leaf spring and a friction element, the friction element operably connected to the lever arm, wherein the leaf spring is in contact with the friction surface in the non-sprung mode, and is moved out of contact with the friction surface in the center-sprung mode.

4. The remote control unit of claim 3, wherein the mechanical mode toggle comprises a hook, the friction element comprising a friction wheel, the hook pushing the leaf spring out of contact with the friction wheel in the center-sprung mode.

5. The remote control unit of claim 3, wherein the friction element is configured to maintain a position of the lever arm in the non-sprung mode after the lever arm has been rotated in the first direction until an external force overcomes a friction between the friction element and the leaf spring.

6. The remote control unit of claim 1, wherein the mechanical mode toggle disengages the barometric pressure sensor switch in the center sprung mode and engages the barometric pressure sensor switch in the non-sprung mode.

7. The remote control unit of claim 2, wherein the mechanical mode toggle comprises a slot configured to accommodate a pin on the rocker arm,
wherein the mechanical mode toggle is configured to rotate to push the pin to a first location to bring at least one of the two bars into contact with the rocker arm in the center-sprung mode, the pin configured to move freely in the slot in the center-sprung mode, and
wherein the mechanical mode toggle is configured to rotate to push the pin to a second location to bring both of the two bars out of contact with the rocker arm, the pin being push to one end of the slot in the non-sprung mode.

8. The remote control unit of claim 1, further comprising a torsional spring mounted at one end on an outer housing of the remote control unit, the torsional spring being connected to the mechanical mode toggle on another end, the torsional spring locking the toggle into in the center-sprung mode by biasing in a first direction and locking the toggle into the non-sprung mode by biasing in a second direction opposite the first direction.

9. The remote control unit of claim 1, wherein the mechanical mode toggle comprises a thumb wheel.

10. The remote control unit of claim 1, wherein when activated, the barometric pressure sensor is configured to maintain an altitude of the drone.

11. The remote control unit of claim 5, wherein when the barometric pressure sensor is deactivated, an altitude of the drone is maintained by a position of the lever arm in the first direction.

12. A remote control unit for wirelessly controlling an unmanned flying device, the remote control unit having a user input with selectable center sprung and non-sprung modes, the remote control unit comprising:
a gimbal configured for rotation in a first direction and a second direction, the first direction being substantially perpendicular to the second direction, the gimbal comprising a lever arm configured for manipulation by a user to effectuate rotation in the first and second directions, the gimbal further comprising a friction surface that, when in contact with a stopper arm in the center-sprung mode, is configured to hold the lever am in a stationary rotational position with respect to the first direction until an external force is applied to the lever arm that overcomes a friction force between the friction surface and the stopper arm;
at least one spring operably connected to the gimbal and configured to return the lever arm to a center position in the center sprung mode after the lever arm is released from a non-center position in the first direction, wherein the gimbal is operably disconnected from the spring in the non-sprung mode;
a barometric pressure sensor switch comprising activated and deactivated configurations;
a mechanical mode toggle, the mechanical mode toggle further comprising a hook, wherein in the center-sprung mode, the mechanical toggle is configured to operably connect the gimbal to the spring, deactivate the barometric pressure sensor switch, and cause the hook to push the stopper arm away from the friction surface, and when in the non-sprung mode, the mechanical mode toggle is configured to operably disconnect the gimbal from the spring, activate the barometric pressure sensor switch, and causes the hook to push the stopper arm against the friction surface; and
a controller configured to wirelessly communicate with the unmanned flying device, the controller configured to, responsive to detecting activation or deactivation of the barometric pressure sensor switch, transmit data to the unmanned flying device to cause the unmanned flying device to activate or deactivate a barometric pressure sensor.

13. The remote control unit of claim 12, further comprising a rocker arm coupled to one end of the at least one spring, the lever arm being connected to two bars in the first direction with one bar on each side of a center of rotation of the lever arm in the first direction, the bars and the rocker arm being in contact in the center-sprung mode such that rotation of the lever arm throughout a range of motion in the first direction is translated to movements of the rocker arm by at least one of the two bars and exerts a tensile force on the at least one spring, wherein the bars and the rocker arm are not in contact in the non-sprung mode such that rotation of the lever arm throughout the range of motion in the first direction does not exert a tensile force on the at least one spring.

14. The remote control unit of claim 13, wherein the rocker arm comprises a pin, the pin being biased to a first location to bring at least one of the two bars into contact with the rocker arm in the center-sprung mode, and wherein the mechanical mode toggle is configured to rotate to push the pin to a second location to bring both of the two bars out of contact with the rocker arm in the non-sprung mode.

15. The remote control unit of claim 12, wherein the mechanical mode toggle disengages the barometric pressure sensor switch to activate the switch in the center sprung mode and engages the barometric pressure sensor switch to deactivate the switch in the non-sprung mode.

16. The remote control unit of claim 12, further comprising a torsional spring pivoted at one end on an outer housing of the remote control unit, the torsional spring being connected to the mechanical mode toggle on another end, wherein the torsional spring is configured to lock the toggle into in the center-sprung mode by biasing in the first direction and lock the toggle into the non-sprung mode by biasing in the second direction opposite the first direction

17. The remote control unit of claim 12, wherein the mechanical mode toggle comprises a thumb wheel.

18. The remote control unit of claim 12, wherein when activated, the barometric pressure sensor is configured to maintain an altitude of the drone.

19. The remote control unit of claim 12, wherein when the barometric pressure sensor is deactivated, an altitude of the drone is maintained by a position of the lever arm in the first direction.

20. A remote control unit for controlling an unmanned flying device, the remote control unit having a user input with selectable center sprung and non-sprung modes, the remote control unit comprising:
a gimbal comprising a stationary housing and a rotatable drum, the drum pivotally coupled to the housing such that the drum can rotate with respect to the housing about a first axis;
a joystick coupled to the drum, the joystick configured for manipulation by a user to cause rotation of the drum about the first axis;
a rocker arm pivotally coupled to the housing such that the rocker arm can rotate with respect to the housing about a second axis,
wherein the drum comprises first and second laterally protruding members positioned to engage the rocker arm;
a spring coupled to the rocker arm and configured to bias the rocker arm toward the first and second laterally protruding members of the drum,
wherein the laterally protruding members and the rocker arm are positioned such that, when the rocker arm engages one or both of the laterally protruding members, the spring and rocker arm bias the joystick toward a centered position; and
a toggle switch configured for manipulation by a user to alternate the gimbal between center sprung and non-sprung modes, the toggle switch having first and second positions,
wherein, when the toggle switch is in the first position, the rocker arm is able to engage at least one of the first and second laterally protruding members throughout a range of motion of the joystick, to cause the joystick to be center sprung about the first axis, and
wherein, when the toggle switch is in the second position, the rocker arm is forced out of engagement with both the first and the second laterally protruding members, to cause the joystick to be non-sprung about the first axis.

21. The remote control unit of claim 19, wherein the rocker arm comprises a laterally protruding member that extends into a slot of the toggle switch, the slot shaped such that, when the toggle switch is in the first position, the laterally protruding member of the rocker arm can move freely within the slot in response to rotation of the drum about the first axis, and when the toggle switch is in the second position, the laterally protruding member of the rocker arm is forced against an end of the slot.

22. The remote control unit of claim 20, wherein the rocker arm comprises a laterally protruding member and the toggle switch comprises a laterally protruding member, the laterally protruding members of the rocker arm and toggle switch positioned such that, when the when the toggle switch is in the first position, the laterally protruding member of the rocker arm can move freely relative to the laterally protruding member of the toggle switch in response to rotation of the drum about the first axis, and when the toggle switch is in the second position, the laterally protruding member of the rocker arm is forced against the laterally protruding member of the toggle switch.

23. The remote control unit of claim 19, further comprising:
a friction member positioned to contact a surface of the drum such that, when the joystick is non-sprung about the first axis, the joystick will be held in a stationary rotational position with respect to the first axis until an external force is applied to the joystick that overcomes a friction force between the friction member and the surface of the drum, and
wherein, when the toggle switch is in the first position, the friction member is forced out of engagement with the surface of the drum.

24. The remote control unit of claim 19, further comprising:
an electronic switch positioned to detect whether the toggle switch is in the first position or the second position.

25. The remote control unit of claim 24, further comprising:
a transmitter configured to transmit data to an unmanned flying device, the data comprising at least an indication of a present state of the electronic switch.
